(19) United States
(12) Patent Application Publication
(10) Pub. No.: US 2024/0149910 A1
(43) Pub. Date: May 9, 2024

(54) SELF PROPELLED TRAILER SYSTEM

(71) Applicant: FCA US LLC, Auburn Hills, MI (US)

(72) Inventors: Mark E. Stout, II, Waterford, MI (US); Travis D. Bechtel, Goodrich, MI (US); Brandon Brady, Lapeer, MI (US); Mac Lynch, Waterford, MI (US)

(21) Appl. No.: 18/308,836

(22) Filed: Apr. 28, 2023

Related U.S. Application Data
(60) Provisional application No. 63/423,218, filed on Nov. 7, 2022.

(51) Int. Cl. B60W 60/00; B60W 30/09; B60W 50/14; B62D 13/06

(52) U.S. Cl. CPC B60W 60/001; B60W 30/09; B60W 50/14; B62D 13/06; B60W 2300/14; B60W 2552/53

(57) ABSTRACT

A multi-vehicle control system (MVCS) for dynamic stability and control of a multi-vehicle system having a lead vehicle and a trailer vehicle each with independent propulsion and control. The MVCS includes a controller in signal communication with the lead vehicle and a trailer vehicle advanced driver assistance system (ADAS) or autonomous driving system via a controller area network (CAN) bus. The controller is configured to (i) receive throttle, brake, and steering signals respectively from a throttle-by-wire system, a brake-by-wire system, and a steer-by-wire system of the trailer vehicle ADAS or autonomous driving system, (ii) receive lead vehicle control inputs from the lead vehicle, and (iii) modify a throttle, a steering, and a braking of the trailer vehicle, based on the received lead vehicle control inputs, to dynamically stabilize the multi-vehicle system such that the trailer vehicle does not induce forces that accelerate or slow the lead vehicle.

### CROSS-REFERENCE TO RELATED APPLICATION

This application claims the benefit of U.S. Provisional Pat. App. No. 63/423,218 filed Nov. 7, 2022, the contents of which are incorporated herein by reference thereto.

### FIELD

The present application relates generally to vehicle trailer systems and, more particularly, to a multi-vehicle control system for self-propelled vehicle trailer systems.

### BACKGROUND

Trailer towing is a complex task that typically requires significant driver attention and skill. One drawback of conventional towing is that the trailer passively responds to mechanical inputs and constraints of the towing vehicle. As such, trailer systems typically do not follow the exact path of the lead vehicle, which may increase the possibility of damage to the trailer or surrounding property, particularly during turning maneuvers. Moreover, towing/hitch systems transfer load from the trailer to the rear of lead vehicle, thus requiring the lead vehicle to have a payload carrying capability proportional to the trailer weight. Additionally, the towing/hitch systems can potentially induce undesirable forces to the lead vehicle that can potentially destabilize the forward motion of the lead vehicle (sway) or impart harsh impacts/noises into the lead vehicle chassis under acceleration and deceleration conditions. Accordingly, while such conventional trailer systems work well for their intended purpose, there is a desire for improvement in the relevant art.

### SUMMARY

In accordance with an example aspect of the invention, a multi-vehicle control system (MVCS) for dynamic stability and control of a multi-vehicle system having a lead vehicle and a trailer vehicle each with independent propulsion and control is provided. In one example implementation, the MVCS includes a controller in signal communication with the lead vehicle and a trailer vehicle advanced driver assistance system (ADAS) or autonomous driving system via a controller area network (CAN) bus. The controller is configured to (i) receive throttle, brake, and steering signals respectively from a throttle-by-wire system, a brake-by-wire system, and a steer-by-wire system of the trailer vehicle ADAS or autonomous driving system, (ii) receive lead vehicle control inputs from the lead vehicle, and (iii) modify a throttle, a steering, and a braking of the trailer vehicle, based on the received lead vehicle control inputs, to dynamically stabilize the multi-vehicle system such that the trailer vehicle does not induce forces that accelerate or slow the lead vehicle.

In addition to the foregoing, the described trailer system may include one or more of the following: wherein the controller is further configured to modify a throttle, a steering, and a braking of the lead vehicle, based on the received trailer vehicle throttle, brake, and steering signals, to further dynamically stabilize the multi-vehicle system such that the trailer vehicle does induce forces that accelerate or slow the lead vehicle; and wherein the controller is further configured to display information about the trailer vehicle to a display integrated into the lead vehicle and/or a non-integrated trailer information display.

In addition to the foregoing, the described trailer system may include one or more of the following: wherein the controller is in signal communication with a lead vehicle ADAS or autonomous driving system; wherein the controller is further configured to detect lane lines based on signals received from one or more cameras of the lead vehicle ADAS or autonomous driving system, and modify the steering of the trailer vehicle, based on the detected lane lines, to locate the trailer vehicle in a predetermined position within the detected lane lines; and wherein the controller is further configured to modify the steering of the lead vehicle, based on the detected lane lines, to locate the lead vehicle in a second predetermined position within the detected lane lines relative to the trailer vehicle.

In addition to the foregoing, the described trailer system may include one or more of the following: wherein the lead vehicle and the trailer vehicle are coupled by a tow bar system that includes at least one angle sensor configured to sense a first angle between the lead vehicle and the tow bar system, and a second angle between the trailer system and the tow bar system, an extension sensor configured to measure a level of extension of the tow bar system, and a load cell configured to sense forces on the tow bar system, wherein the controller is in signal communication with the at least one angle sensor, the extension sensor, and the load cell; wherein the controller is further configured to receive signals from the at least one angle sensor, the extension sensor, and the load cell, and further modify the throttle, the steering, and the braking of the trailer vehicle, based on the signals received from the tow bar system, to dynamically stabilize the multi-vehicle system such that the trailer vehicle does not induce forces that accelerate or slow the lead vehicle.

In addition to the foregoing, the described trailer system may include one or more of the following: wherein the controller is further configured to modify a throttle, a steering, and a braking of the lead vehicle, based on the signals received from the tow bar system, to further dynamically stabilize the multi-vehicle system such that the trailer vehicle does not induce forces that accelerate or slow the lead vehicle; and wherein the controller is further configured to match a throttle response of the trailer vehicle to a throttle input of the lead vehicle, and match a braking response of the trailer vehicle to a braking input of the lead vehicle.

In accordance with another example aspect of the invention, a control method is provided for dynamic stability of a multi-vehicle system having a multi-vehicle control system (MVCS) in signal communication with a lead vehicle and a trailer vehicle each with independent propulsion and control. In one example, the control method includes (i) receive, by a controller of the MVCS having one or more processors, throttle, brake, and steering signals respectively from a throttle-by-wire system, a brake-by-wire system, and a steer-by-wire system of an advanced driver assistance system (ADAS) or autonomous driving system of the trailer vehicle, (ii) receive, by the controller, lead vehicle control inputs from the lead vehicle, and (iii) modify, by the controller, a throttle, a steering, and a braking of the trailer vehicle, based on the received lead vehicle control inputs, to dynamically stabilize the multi-vehicle system such that the trailer vehicle does not induce forces that accelerate or slow the lead vehicle.

In addition to the foregoing, the described method may include one or more of the following: modifying, by the controller, a throttle, a steering, and a braking of the lead vehicle, based on the received trailer vehicle throttle, brake, and steering signals, to further dynamically stabilize the multi-vehicle system such that the trailer vehicle does not induce forces that accelerate or slow the lead vehicle; displaying, by the controller, information about the trailer vehicle to a display integrated into the lead vehicle and/or a non-integrated trailer information display; and wherein the controller is in signal communication with a lead vehicle ADAS or autonomous driving system, the method further including detecting lane lines, by the controller, based on signals received from one or more cameras of the lead vehicle ADAS or autonomous driving system, and modify the steering of the trailer vehicle, by the controller, based on the detected lane lines, to locate the trailer vehicle in a predetermined position within the detected lane lines.

In addition to the foregoing, the described method may include one or more of the following: modifying the steering of the lead vehicle, by the controller, based on the detected lane lines, to locate the lead vehicle in a second predetermined position within the detected lane lines relative to the trailer vehicle; wherein the multi-vehicle system includes a tow bar system coupling the lead vehicle and the trailer vehicle, the tow bar system including (i) at least one angle sensor configured to sense a first angle between the lead vehicle and the tow bar system, and a second angle between the trailer system and the tow bar system, (ii) an extension sensor configured to measure a level of extension of the tow bar system, and (iii) a load cell configured to sense forces on the tow bar system, the method further including (a) receiving, by the controller, signals from the at least one angle sensor, the extension sensor, and the load cell, and (b) further modifying, by the controller, the throttle, the steering, and the braking of the trailer vehicle, based on the signals received from the tow bar system, to dynamically stabilize the multi-vehicle system such that the trailer vehicle does not induce forces that accelerate or slow the lead vehicle.

In addition to the foregoing, the described method may include one or more of the following: modifying, by the controller, a throttle, a steering, and a braking of the lead vehicle, based on the signals received from the tow bar system, to further dynamically stabilize the multi-vehicle system such that the trailer vehicle does not induce forces that accelerate or slow the lead vehicle; and matching, by the controller, a throttle response of the trailer vehicle to a throttle input of the lead vehicle, and matching, by the controller, a braking response of the trailer vehicle to a braking input of the lead vehicle.

In accordance with another example aspect of the invention, a control method is provided for dynamic stability of a multi-vehicle system having a multi-vehicle control system (MVCS) in signal communication with a lead vehicle and a trailer vehicle each with independent propulsion and control, the MVCS in signal communication with an advanced driver assistance system (ADAS) or autonomous driving system of the trailer vehicle. In one example, the control method includes performing, by a controller of the MVCS having one or more processors, the following during high-speed maneuvering: (i) controlling the trailer vehicle to follow the lead vehicle through emergency lane changes in a path that reduces rollover risk, and (ii) determining and executing a horizontal offset between the lead vehicle and the trailer vehicle to reduce aerodynamic drag on the multi-vehicle system. The method further includes performing, by the controller, the following during low-speed maneuvering: controlling the trailer vehicle to follow the lead vehicle through a forward turn on a path to avoid obstacles detected by the trailer vehicle ADAS or autonomous driving system.

In addition to the foregoing, the described method may include one or more of the following: wherein the MVCS is further in signal communication with an ADAS or autonomous driving system of the lead vehicle, the method further including performing, by the controller, the following during high-speed maneuvering: modifying driver input responses of the lead vehicle, including modifying throttle, brake, and steering outputs, based on signals from the trailer vehicle ADAS or autonomous driving system. The method further includes performing, by the controller, the following during low-speed maneuvering: (i) controlling the trailer vehicle to follow the lead vehicle through the forward turn further based on lead vehicle driver inputs, (ii) initiating a rearward turn of the trailer vehicle based on driver inputs from the lead vehicle, and subsequently controlling the lead vehicle to follow a path of the trailer vehicle through the rearward turn, (iii) scanning for hazards utilizing the ADAS or autonomous driving systems of both the lead vehicle and the trailer, (iv) alerting a driver of the lead vehicle of detected hazards, and (iv) executing one or more maneuvers in the lead vehicle and/or the trailer vehicle to prevent a collision with the detected hazards.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example dolly platform system with independent propulsion and control, in accordance with the principles of the present application;

FIG. 2 is a bottom view of the dolly platform system shown in FIG. 1, in accordance with the principles of the present application;

FIG. 3 is a bottom view of an example trailer platform system in accordance with the principles of the present application;

FIG. 4 is a side view of the trailer platform system shown in FIG. 3, in accordance with the principles of the present application;

FIG. 5 is a schematic illustration of an example tow bar system connecting a lead vehicle and a trailing vehicle, in accordance with the principles of the present application;

FIG. 6 is a perspective view of the example tow bar system shown in FIG. 5, in accordance with the principles of the present application;

FIG. 7 is a perspective view of the example tow bar system shown in FIG. 6 with an example horizontal lockout assembly, in accordance with the principles of the present application;

FIG. 8 is a schematic illustration of a multi-vehicle system with a lead vehicle and self-powered trailer in accordance with the principles of the present application;

FIGS. 9A-9B are a schematic illustration of a multi-vehicle control system (MVCS) of the multi-vehicle system of FIG. 8, in accordance with the principles of the present application;

FIG. 10 is a functional block diagram of an example control architecture of the MVCS, in accordance with the principles of the present application;

FIG. 11 is a functional block diagram of another example control architecture of the MVCS, in accordance with the principles of the present application;

FIG. 12 is a functional block diagram of yet another example control architecture of the MVCS, in accordance with the principles of the present application;

FIGS. 13A-13B illustrate a flow diagram of an example method of controlling the multi-vehicle system with the MVCS, in accordance with the principles of the present application;

FIG. 14 illustrates a flow diagram of another example method of controlling the multi-vehicle system with the MVCS, in accordance with the principles of the present application; and

FIGS. 15A-15B illustrate a flow diagram of yet another example method of controlling the multi-vehicle system with the MVCS, in accordance with the principles of the present application.

### DETAILED DESCRIPTION

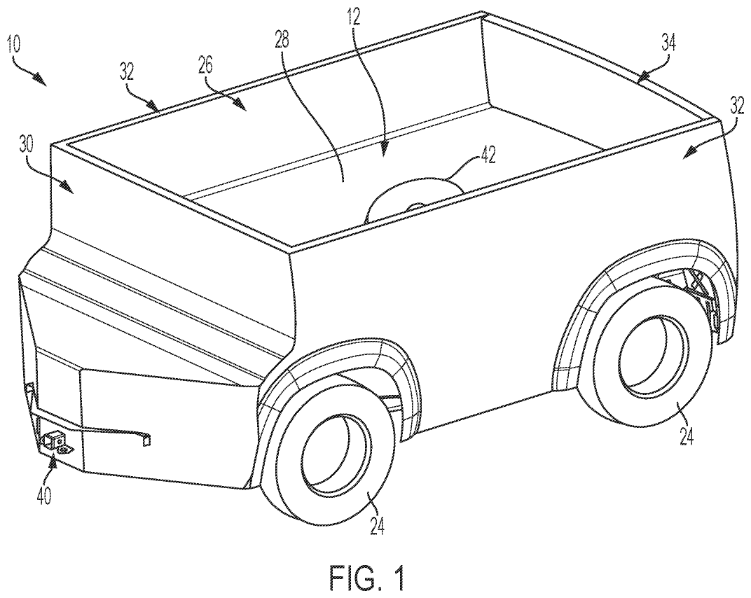

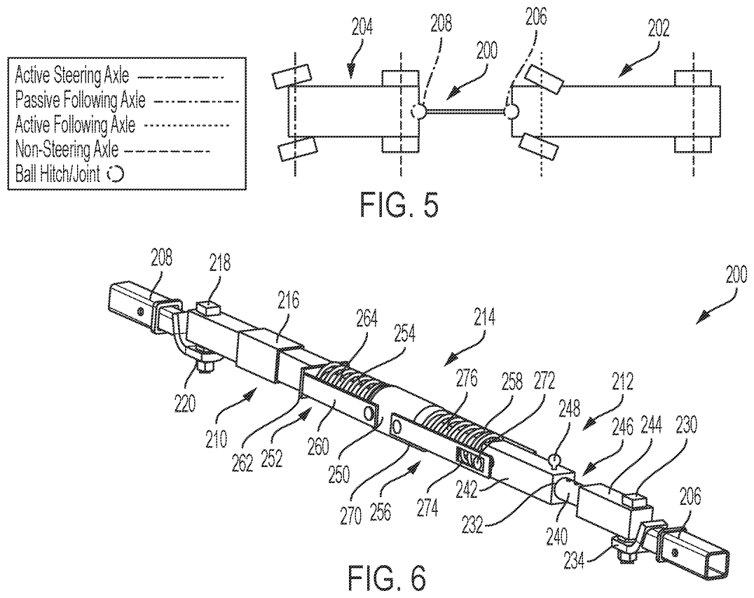

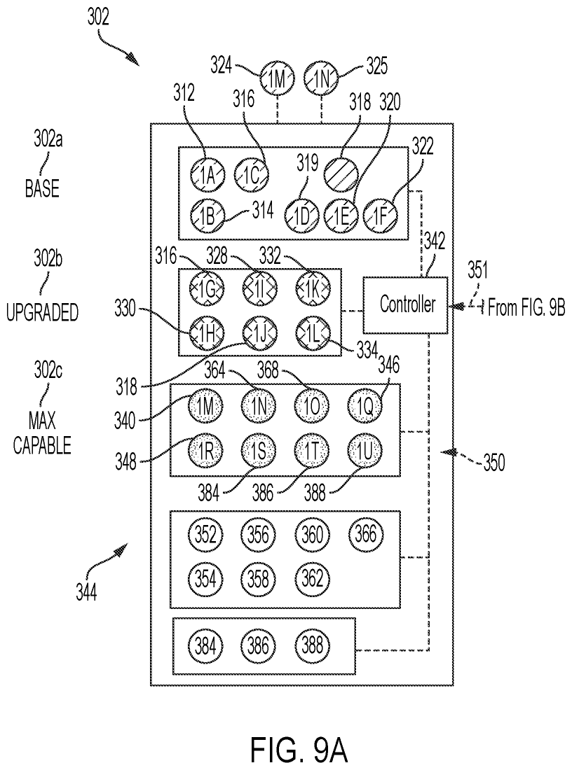

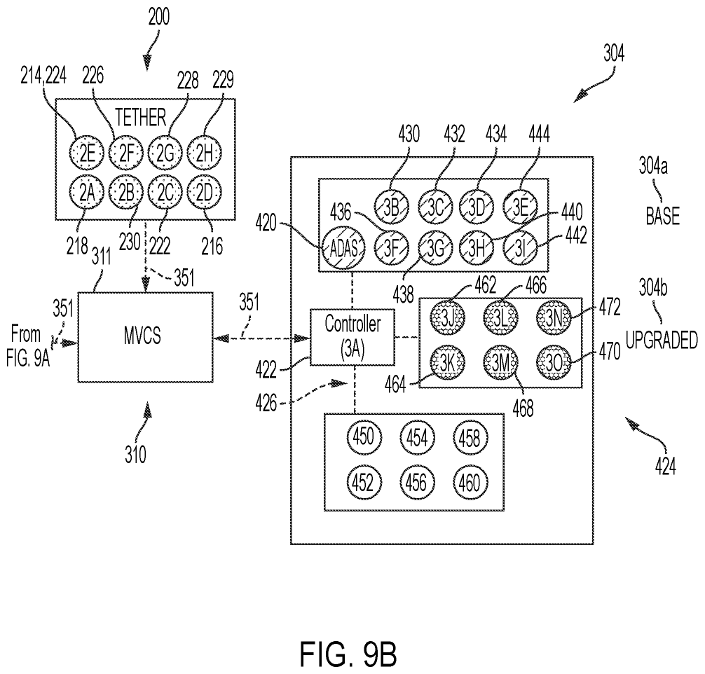

Described herein are control systems for multi-vehicle systems that include a lead vehicle and a self-propelled, battery electric vehicle (BEV) based trailer system. The BEV trailers may be, for example, a wagon style (e.g., wheels at four corners) or traditional chassis trailer with a steerable axle such as those shown in FIGS. 1-4. Additionally, the BEV trailers may utilize a tow bar system such as that shown and described in FIGS. 5-7. The control systems include input and output parameters for multiple motorized and steerable vehicles controlled by a single driver. Rather than having the driver actuate one vehicle and a traditional trailer passively react, all vehicles of the multi-vehicle system are actuated (e.g., controlled) by a single control input. This control affects all aspects of the vehicle dynamic performance including steering, braking, acceleration, reversing maneuvers, and ADAS or autonomous driving systems. Example vehicle systems are described in FIGS. 1-8. Example multi-vehicle control systems and methods are described in FIGS. 9-15.

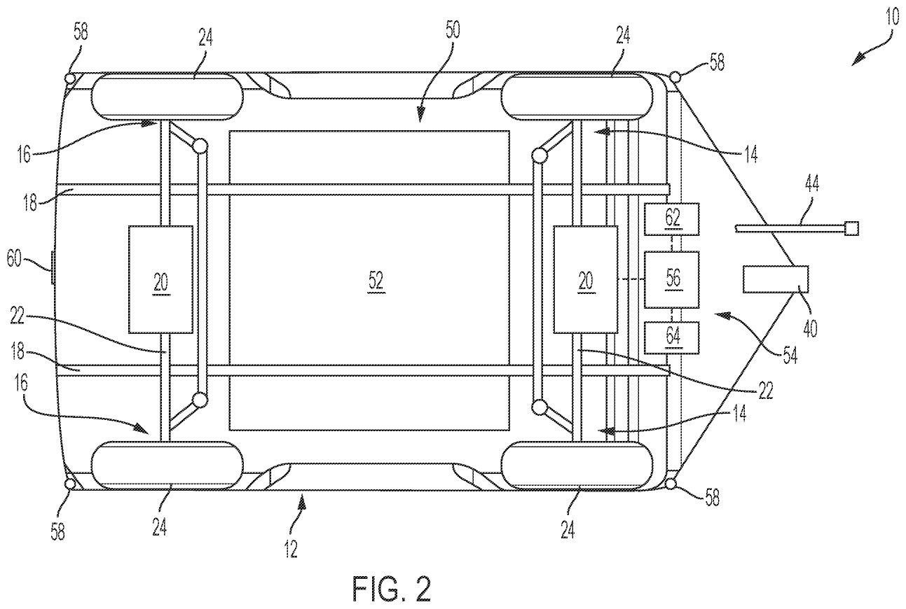

With reference now to FIGS. 1 and 2, the trailer supporting dolly system with independent propulsion and control will be describe in more detail. In some examples, the trailer-supporting dolly system is an auxiliary power dolly that enables small vehicles to tow a trailer such as a gooseneck, fifth wheel, or traditional bumper-pull trailer. The dolly system provides the motive force and energy needed to tow a trailer via an electrified powertrain and batteries. The dolly system attaches to the lead vehicle via a tow bar and supports heavier loads and taller hitch height of a trailer that is specifically designed for trucks with in-bed connections (e.g., fifth wheel, gooseneck). The dolly system functions as a steering axle for the trailer to control its motion via steer-by-wire, and allows separate low-speed remote maneuvering for parking in confined spaces such as parking lots, campgrounds or charging stations.

The dolly system includes suspension (rate and travel) similar to the rear axle of one-ton DRW trucks or enclosed cargo vans. This provides the dolly system with its own ground force reactions for steering, acceleration, and braking to manage loading into the trailer hitch structure similar to “free pivot” designs. The dolly system can also include modular functionality greater than a pickup truck with a bed. For example, the dolly system can include a dump bed with modular side panels that transition between a flat bed and a walled-in bed depending on the cargo. The walled-in bed can include conventional bed sides/walls and a cover for typical truck bed usage. Because the dolly system can be remotely maneuvered at low speeds, the system is highly maneuverable for utility uses such as dumping mulch, collecting/moving firewood, waste/dumpster disposal, etc.

In the example embodiments, the dolly system is configured to support the weight of any type of trailer hitch and acts as an intermediary between the lead vehicle and the trailer. The intermediate body creates backwards compatibility between EVs and older trailers without their own power source. Onboard batteries improve range of the EV/trailer, and allow a smaller lead vehicle to tow a large trailer by handling most or all of the braking and accelerating. The front steering axle pulls the trailer around corners and allows it to accurately follow the lead vehicle path. A low-speed remote maneuvering function allows the trailer to steer into tight spaces with ease. The dolly system's truck bed sides and small size allow users to experience the functionality and utility of a truck only when they need it, allowing them to own a smaller, cheaper, and more fuel-efficient vehicle that suits daily use needs.

The dolly system described herein advantageously provides backwards compatibility for EVs to pull older trailers, does not require users to purchase a new trailer in order to maintain towing range, and allows the driver to steer the trailer much more easily than a conventional trailer because of the active steering axle. The system also provides more control than the passive steering axle of an automated safety hitch, and allows a much smaller vehicle to tow/lead the trailer because of the stability of its four-wheeled chassis and electrified powertrain. As such, the dolly system does all the work of braking, accelerating and steering of the trailer, leaving the lead vehicle to simply be a guide.

With continued reference to FIGS. 1 and 2, a trailer-supporting tug/dolly platform system 10 with independent and autonomous propulsion and control is illustrated. The dolly system 10 advantageously provides a non-powered trailer with a powered trailer having autonomous steering capabilities. The dolly system 10 includes a load platform 12 located above and supported by a front suspension 14, a rear suspension 16, and a frame or chassis 18. The dolly system 10 includes an electric powertrain having one or more electric traction motors 20 that generate and transfer torque to one or more steerable axles 22 and wheels 24 via intermediate components (e.g., a transmission, shafts, differential). The electric traction motor(s) 20 are electrically coupled to and powered by a high voltage battery system 50 having one or more battery packs or modules 52, as described herein in more detail.

In one exemplary implementation, the dolly system 10 is similar to a pickup truck bed, as illustrated. The load platform 12 provides a truck bed or cargo area 26 defined at least partially by a floor 28, a forward wall 30, side walls 32, and a tailgate 34. One or more of the forward wall 30, side walls 32, and tailgate 34 may be removable to transition the dolly system 10 into various configurations for towing and/or cargo hauling. Moreover, the load platform 12 may be articulatable to function as a dump bed.

In the example embodiment, the dolly system 10 includes a lead vehicle hitch connection 40, a trailer hitch structure 42, and a high voltage power connection 44. The lead vehicle hitch connection 40 is configured for removable coupling with a lead vehicle (not shown), for example via the tow bar system 200 described herein. The trailer hitch structure 42 is coupled to the floor 28 and configured to removably couple to a trailer (not shown) such as a fifth wheel or gooseneck trailer. The high voltage power connection 44 is configured to electrically couple to a corresponding connection of the lead vehicle (not shown). The high voltage connection 44 is electrically coupled to the battery pack(s) 52 to enable power connection between the dolly system 10 and the lead vehicle. In this way, battery charge can be shared or redirected between the electric dolly system 10 and an electric lead vehicle.

As shown in FIG. 2, the dolly system 10 includes an advanced driver assistance system (ADAS)/autonomous driving system 54 that generally includes a controller 56, one or more sensors 58, one or more cameras 60, a steer-by-wire control module 62, and one or more actuators 64. The controller 56 is configured to control operation of the dolly system 10 as well as execute at least one ADAS/autonomous driving feature. The sensors 58 and cameras 60 are configured to capture/measure data utilized by the ADAS/autonomous driving system 54 to control the dolly system 10. The steer-by-wire control module 62 is configured to operate the actuators 64 to control driving/operation of the dolly system 10 as part of the ADAS/autonomous driving feature. In this way, the controller 56 is configured to control the electric traction motor(s) 20 and the steerable axle(s) 22 and can be configured for autonomous or manual control of the dolly system 10. Moreover, the controller 56 or other components (e.g., sensors 58, cameras 60) of the ADAS/autonomous driving system 54 may be in signal communication with the lead vehicle (e.g., via electrical connection, wireless, CAN bus, lead vehicle ADAS system, etc.) for cooperative and integrated operation between the dolly system 10 and lead vehicle.

In operation, the dolly system 10 provides motive force and power to tow a trailer via an electrified powertrain and HV battery system 50, including independently performing some or all braking and acceleration of the trailer. This reduces or eliminates power demands on the towing vehicle for acceleration and braking, which allows a smaller vehicle to tow a larger trailer, since the dolly system 10 can balance itself and is not dependent on the towing vehicle to carry significant trailer tongue weight. The dolly system 10 supports the heavier loads and taller hitch height of a trailer specifically designed for trucks with in-bed connections. Advantageously, the dolly system 10 includes its own suspension 14, 16 to provide its own ground force reactions for steering, acceleration and braking to manage loading in the trailer hitch structure. Moreover, the ADAS/autonomous driving system 54, including the steer-by-wire control module 62, is utilized to control the steering axle(s) 22 to provide and control its own motion of the attached trailer. Additionally, the dolly system 10 can be controlled (e.g., driven) in a low-speed remote maneuvering mode via a control unit (not shown) such as, for example, a user interface in the towing vehicle, a user interface on the dolly system, a smart phone app, etc. This is particularly useful for parking in tight confines such as parking spaces, charging stations, camping sites, etc.

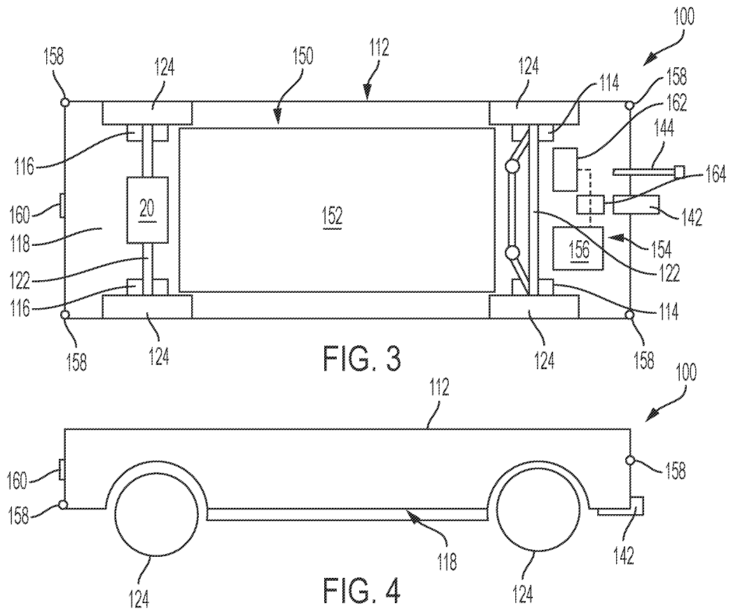

With reference now to FIGS. 3 and 4, the trailer platform system with independent propulsion and control will be described in more detail. In some examples, the trailer platform system is a self-propelled battery electric vehicle (BEV) based, wagon style (e.g., wheel at four corners) trailer, with autonomous driving control capability. The trailer platform system generally includes a chassis, wheels, tires, suspension, brakes, a battery pack, electric drive motor(s), control modules (e.g., controllers), a steer-by-wire system, camera(s), and/or sensor(s). The system operates by interacting with some or all of the following components on the lead vehicle: vehicle CAN bus, trailer hitch load cell, vehicle dynamics control module(s), and autonomous sensors and ADAS control module(s). The system is also configured to share battery charge between the lead vehicle and the trailer platform.

In the example embodiment, the trailer platform system provides the motive force and energy needed to tow a trailer via an electrified powertrain and batteries. The system attaches to the lead vehicle (e.g., through a wireless or wired connection and a tow bar) and is configured to support its own weight. The trailer includes a steering axle to control its motion via steer-by-wire and allows separate low-speed remote maneuvering. The trailer system includes a suspension (rate and travel) similar to the rear axle of a one-ton DRW truck or enclosed cargo van to provide its own ground force reactions for steering, acceleration and braking, to thereby manage loading and clearance to the lead vehicle. In one example, with a highly autonomous lead vehicle, the lead vehicle can control the trailer remotely to the autonomy level, and associated cost and weight of the trailer can be reduced by eliminating the ADAS sensors and controllers from the trailer.

In some examples, the included battery pack, motor(s), and controller(s) are sized to reduce or eliminate power demands on the lead vehicle for acceleration and braking. The wagon style trailer setup (with wheels at the four corners of the trailer instead of near the middle of the trailer length for traditional towed trailers) will allow a smaller vehicle to tow a larger trailer, since the trailer can balance itself and is not dependent on the lead vehicle to carry significant trailer tongue weight. The dynamic steering and propulsion/braking capability allows the trailer to correct the trailer's path when turning while moving in forward or reverse to follow the lead vehicles intended path more closely than traditional trailers. This can also allow for trailer obstacle avoidance and enhanced trailer stability control.

The trailer platform system advantageously provides autonomous dynamic control (e.g., acceleration, braking, steering) to a trailer, controlled either through self-contained systems or communication with lead vehicle autonomous systems. The wagon-style chassis can be used in light and medium duty trailer categories for on-road use. The actively steered axle allows greater steering control and the ability to reverse as compared to low-speed farm/utility wagons.

With continued reference to FIGS. 3 and 4, a trailer platform system 100 with independent and autonomous propulsion and control is illustrated. The trailer platform system 100 includes a load platform 112 located above and supported by a front suspension 114, a rear suspension 116, and a frame or chassis 118. The trailer platform system 100 includes an electric powertrain having one or more electric traction motors 120 that generate and transfer torque to one or more steerable axles 122 and wheels 124 via intermediate components (e.g., a transmission, shafts, differential). The electric traction motor(s) 120 are electrically coupled to and powered by a high voltage battery system 150 having one or more battery packs or modules 152. As illustrated, in the example embodiment, the wheels 124 are located at the four corners of the trailer instead of near the middle of the trailer length.

In the example embodiment, the trailer platform system 100 includes a lead vehicle hitch connection 142 and a high voltage power connection 144. The hitch connection 142 is coupled to the chassis 118 and is configured for removable coupling with a lead vehicle (not shown), for example via the tow bar system 200 described herein. The high voltage power connection 144 is configured to electrically couple to a corresponding high voltage connection of the lead vehicle (not shown). The high voltage power connection 144 is electrically coupled to the battery pack(s) 152 to enable power connection between the trailer platform system 100 and the lead vehicle. In this way, battery charge can be shared or redirected between the electrically driven trailer platform system 100 and an electric lead vehicle.

As shown in FIG. 3, the trailer platform system 100 includes an advanced driver assistance system (ADAS)/autonomous driving system 154 that generally includes a controller 156 (e.g., PCM), one or more sensors 158, one or more cameras 160, a steer-by-wire control module 162, and one or more actuators 164. The controller 156 is configured to control operation of the trailer platform system 100 as well as execute at least one ADAS/autonomous driving feature. The sensors 158 and cameras 160 are configured to capture/measure data utilized by the ADAS/autonomous driving system 154 to control the trailer platform system 100. The steer-by-wire control module 162 is configured to operate the actuators 164 to control driving/operation of the trailer platform system 100 as part of the ADAS/autonomous driving feature. In this way, the controller 156 is configured to control the electric motor(s) 120 and the steerable axle(s) 122 and can be configured for autonomous or manual control of the trailer platform system 100. Moreover, the controller 156 or other components (e.g., sensors 158, cameras 160) of the ADAS/autonomous driving system 154 may be in signal communication with the lead vehicle (e.g., via electrical connection, wireless connection, CAN bus, lead vehicle ADAS system, etc.) for cooperative and integrated operation between the trailer platform system 100 and lead vehicle.

In operation, the trailer platform system 100 provides motive force and power to tow a trailer via an electrified powertrain and HV battery system 150, including independently performing some or all braking and acceleration of the trailer. This reduces or eliminates power demands on the towing vehicle for acceleration and braking, which allows a smaller vehicle to tow a larger trailer, since the trailer platform system 100 can balance itself and is not dependent on the towing vehicle to carry significant trailer tongue weight. Advantageously, the trailer platform system 100 includes its own suspension 114, 116 to provide its own ground force reactions for steering, acceleration and braking to manage loading in the trailer hitch structure. Moreover, the ADAS/autonomous driving system 154, including the steer-by-wire control module 162, is utilized to control the steering axle(s) 122 to provide and control its own trailer motion. Additionally, the trailer platform system 100 can be controlled (e.g., driven) in a low-speed remote maneuvering mode via a control unit (not shown) such as, for example, a user interface in the towing vehicle, a user interface on the trailer platform system, a smart phone app, etc. This is particularly useful for parking in tight confines such as parking spaces, charging stations, camping sites, etc.

With reference now to FIGS. 5-7, the tow bar system will be described in more detail. In some examples, the tow bar system is configured for independently steered and powered trailers and includes: (a) a five degree of freedom connection at both ends of the tow bar to allow articulation between the two vehicles, (b) a means of adjusting the length of the bar between the lead and follow vehicles, (c) a means of locking the adjusted length after the connection has been made between the vehicles, (d) a means to absorb harsh compressive loads that could occur while braking or steering, (e) a means to absorb harsh tensile loads that could occur while accelerating or steering, (f) a means to support and route an electrical cable connection between the lead and follow vehicles, (g) an optional means to sense angular difference between the tow bar and either one or both lead and follow vehicle, (h) a means of sensing tensile and compressive loads in the tow bar, and/or (i) an optional means to lockout the lateral steering degree of freedom at one end of the tow bar. The mechanical assembly is configured to attach between the rear trailer towing connection of the lead vehicle and a front/center towing connection like a typical rear towing connection.

The tow bar system provides a physical linkage between two vehicles that have the independent ability to accelerate and decelerate (fore/aft) via human or autonomous control, and steer laterally via human or autonomous driving control. The system provides additional degrees of freedom as a link between the two vehicles to allow improved articulation between the leading and following vehicles, leaving only a tension/compression load and nominal length constraint. The system does not support vertical loading between the two vehicles, so no weight is transferred therebetween and having a negative effect on the handling of them individually or as a pair. The system also does not transfer lateral moment loading between the vehicles unless a tensile or compressive load is created by a speed differential between the vehicle attachment points. This feature will eliminate any possibility of the following vehicle imparting trailer sway to the lead vehicle, and allow the lead and follow vehicles to maintain an offset within the lane width when it may be advantageous for crosswind drag or visibility in outside lanes. As such, the tow bar system allows vehicles that may be mismatched in terms of turning radius (e.g., due to differences in wheelbase) to follow in a best fit path via independent physical, but electronically linked steering, acceleration, and braking controls.

Additionally, the tow bar system advantageously provides one or more of the following optional benefits over conventional trailer attachment: (a) additional angular tolerance for the connection eliminates the need for jacking or height adjustments on flat or angled ground; (b) optional selectable length adjustment combined with feature (a) eliminates the need for a precise distance between the two vehicles; (c) once the mechanical connections have been made the nominal length will be set and locked at the bar, or by moving one of the vehicles to the next locking point; (d) allowing for some compression travel within the tow bar will allow for latency between the lead vehicle initiating a braking event before the following vehicle can respond precisely. A relatively small amount of compressive travel will reduce the load on the two bar and any shock or bump that might be felt by the vehicle occupants; (e) allowing some extension travel provides the same benefits as feature (d) for acceleration and can also be used if it is desirable for the following vehicle to have a higher braking power to keep the connection in-line with the lead vehicle; (f) the structure of the tow bar can serve as a support for communications and power transfer harnesses between the lead and follow vehicles, though a wired connection may not be required if wireless technology is used; (g) optional measurement of the angle of the tow bar to the lead and follow vehicles could be used as a primary or back-up sensing to the onboard electronics of the lead and/or follow vehicles, while sensing angle directly at the tow bar can prevent jackknife/contact events while making low speed maneuvers in forward or reverse; (h) sensing the tensile and compressive loading present in the tow bar can provide a primary or secondary means of balancing or targeting a desired force during acceleration, cruising at steady speed and braking forces between the two vehicles; and (i) optional ability to lock the lateral pivoting of the tow bar at one end, which allows for the recovery of a following vehicle that may not have lost electrical power to maintain its independent steering operation or may have reduced braking performance. The lock could be set manually or while driving if a loss of power or function is detected.

In some examples, the tow bar system advantageously provides: spherical degrees of freedom at both ends of the tow bar, which allows active steering of the trailing vehicle, as opposed to flat towing where the front wheels of the tow vehicle must follow the path dictated by a rigid tow bar. The system also includes a powered trailer, which allows reversing maneuvers that are not possible with flat towing. Steering of the trailer is controlled electronically, allowing reverse movement without jackknifing, and left-right bias relative to the lead vehicle. The system supplies all or most of the pulling power needed to move the trailer with any lead vehicle, as enabled by a load cell in the tow bar. The system is a simply supported beam connection so the lead vehicle does not have to support the trailer's weight.

With continued reference to FIGS. 5-7, a tow bar system 200 for independently steered and powered trailers is illustrated. As shown in FIG. 5, the tow bar system 200 is configured to removably couple a trailing vehicle 202 (e.g., a trailer) to a lead vehicle 204. The trailing vehicle 202 includes a hitch receiver 206, and the lead vehicle includes a hitch receiver 208. As shown in FIG. 6, the tow bar system 200 generally includes a front tow bar 210 and a rear tow bar 212 coupled by a damper system 214. The tow bar system 200 is configured to support and route an electrical cable connection (not shown) between the lead and follow/tow vehicles, for example to provide signal communication (e.g., from sensors, cameras, etc.) or shared high voltage therebetween.

In the example embodiment, the front tow bar 210 is configured to removably couple to a hitch 220 received by the lead vehicle hitch receiver 208. As illustrated, the front tow bar 210 includes a load cell 216 and an angle sensor 218. The load cell 216 is configured to sense various forces on the tow bar system 200 including a trailer tongue weight, tension, and compression. The angle sensor 218 is configured to sense an angle between the lead vehicle 204 and a longitudinal axis of the front tow bar 210. The load cell 216 and the angle sensor 218 are in signal communication (e.g., wired, wireless) with a controller of the lead vehicle 204 and/or the trailing vehicle 202 (e.g., dolly system 10, trailer platform system 100). Such controllers may be part of an ADAS/automated driving system for that particular vehicle and utilize signals from the load cell 216 and angle sensor 218 to control one or more operations of the vehicles 202, 204.

The rear tow bar 212 is configured to removably couple to a hitch 234 received by the trailing vehicle hitch receiver 206. The rear tow bar 212 includes an angle sensor 230 and a length adjustment and locking mechanism 232. The angle sensor 230 is configured to sense an angle between the trailing vehicle 202 and the longitudinal axis of the rear tow bar 212. The angle sensor 230 is in signal communication (e.g., wired, wireless) with a controller of the lead vehicle 204 and/or the trailing vehicle 202 (e.g., dolly system 10, trailer platform system 100). Such controllers may be part of an ADAS/automated driving system for that particular vehicle and utilize signals from the angle sensor 230 to control one or more operations of the vehicles 202, 204.

In the example embodiment, the length adjustment and locking mechanism 232 generally includes a locking bar 240 extending between a forward bar 242 and a rearward bar 244. The locking bar 240 is rigidly coupled to the rearward bar 244 and is slidingly received within the forward bar 242. The locking bar 240 includes a plurality of axially spaced apertures 246 configured to selectively receive a pin 248 therein to lock-in the relative distance between the forward bar 242 and the rearward bar 244. The pin 248 is removable to allow sliding adjustment of the locking bar 240 to establish a desired length of the rear tow bar 212. It will be appreciated however that rear tow bar 212 may have any suitable alternative configuration that enables length adjustment of the rear tow bar 212, and such a length adjustment system may additionally or alternatively be utilized with the front tow bar 210.

In the example implementation, the damper system 214 is disposed between the front tow bar 210 and the rear tow bar 212 and generally includes a damper 250, a front support 252, a front biasing mechanism 254 (e.g., a spring), a rear support 256, and a rear biasing mechanism 258 (e.g., a spring).

The front support 252 includes a pair of spaced apart support bars or members 260 with first ends coupled to an end plate 262, and opposite second ends coupled to the damper 250. The end plate 262 is coupled to and/or disposed against the front tow bar 210. The front biasing mechanism 254 is disposed about a front guide post 264 and positioned between the end plate 262 and the damper 250. The front guide post 264 is integral with or rigidly coupled to the front tow bar 210 and extends through an aperture formed in the end plate 262. In one example embodiment, the front biasing mechanism 254 is an extension spring configured to bias the front tow bar 210 and damper 250 towards each other, and absorb tensile forces in the tow bar system 200. The damper 250 is a generally cylindrical damping member fabricated from a suitable damping material configured to absorb forces (e.g., tension, compression) experienced in the tow bar system 200 during towing operations.

The rear support 256 includes a pair of spaced apart support bars or members 270 with first ends coupled to the damper 250, and opposite second ends coupled to the rear tow bar 212, for example, via the illustrated pins 272. The second end of each support member 270 includes a window 274 configured to slidingly receive pin 272. In this way, pins 272 are configured to translate fore/aft within the windows 274. The rear biasing mechanism 258 is disposed about a rear guide post 276 and positioned between the damper 250 and the rear tow bar 212. The rear guide post 276 is integral with or rigidly coupled to the rear tow bar 212. In one example embodiment, the rear biasing mechanism 258 is a compression spring configured to bias apart the damper 250 and rear tow bar 212 and absorb compressive forces in the tow bar system 200.

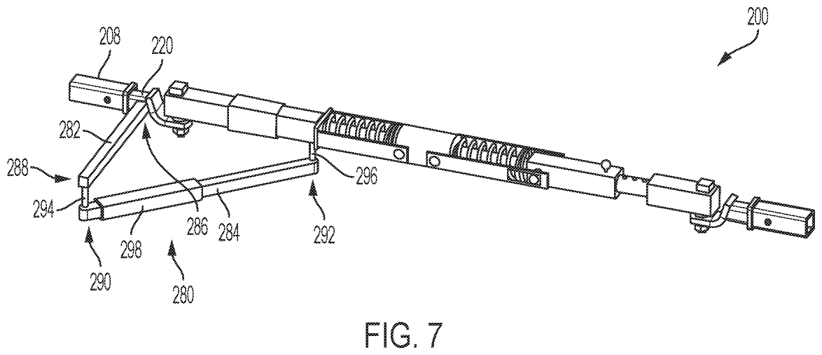

FIG. 7 illustrates the tow bar system 200 with a horizontal lockout assembly 280 configured to lock out the lateral steering degree of freedom at one end of the tow bar if steering control is lost on the trailing vehicle 202. In this way, the horizontal lockout assembly 280 is configured to turn the tow bar system 200 into a rigid tow bar to prevent loss of lateral control.

In the example embodiment, the horizontal lockout assembly 280 generally includes a horizontal bar or member 282 and an angled bar or member 284. The horizontal member 282 includes a first end 286 coupled to the hitch 220 and an opposite second end 288. The angled member 284 includes a first end 290 and an opposite second end 292. The first end 290 is pivotally coupled to the horizontal member second end 288 via a pin 294, and the second end 292 is pivotally coupled to the front tow bar 210 via a pin 296. The angled member 284 includes a sliding joint 298 that enables a length of the angled member 284 to change to allow a full range of articulation of the tow bar system 200. If there is a loss of power and/or communication with the trailing vehicle 202, the sliding joint 298 is configured to lock and prevent loss of lateral control of the trailing vehicle 202.

In operation, the tow bar system 200 is configured to absorb harsh tensile and compressive loads that occur while steering, braking, and accelerating. Moreover, the length of tow bar system 200 is adjustable via the length adjustment and locking mechanism 232. The various sensors included with tow bar system 200 enable sensing of tensile/compressive loads as well as the angular difference between the tow bar and the lead and follow vehicles. This enables a self-powered, steering capable follow vehicle (e.g., dolly system 10, trailer platform system 100) to accelerate/decelerate, brake, and steer via human or autonomous control. As such, the tow bar system 200 enables a vehicle/trailer that may be mismatched in terms of turning radius to follow in a best fit path via independent physical, electronically linked steering, acceleration, and braking controls.

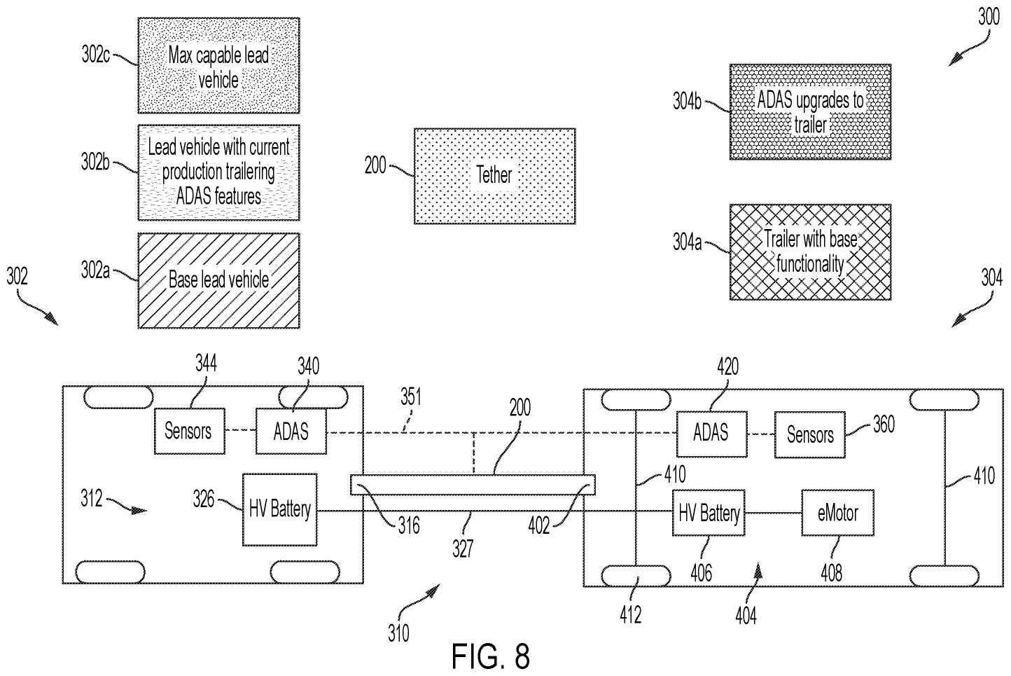

With reference now to FIGS. 8-15, a multi-vehicle system and control will be described in more detail. In the example embodiment, the multiple vehicles include a lead towing vehicle and a self-propelled trailer with a steerable axle (e.g., trailer systems 10, 100), which may include a mechanical linkage therebetween (e.g., tow bar system 200). The control system includes input and output parameters for multiple motorized and steerable vehicles controlled by a single driver. Rather than having the driver actuate one vehicle and a traditional trailer passively react, all vehicles of the multi-vehicle system are actuated (e.g., controlled) by a single control input. This control affects all aspects of the vehicle dynamic performance including steering, braking, acceleration, reversing maneuvers, and ADAS or autonomous driving systems.

With continued reference to FIG. 8, a multi-vehicle system 300 includes a lead vehicle 302 and one or more self-propelled trailer vehicles 304 that may be connected via a tether such as tow bar system 200 (shown in FIGS. 5-7). In other examples, the vehicles 302, 304 operate without a mechanical linkage therebetween. In the example embodiment, the multi-vehicle system 300 includes a multi-vehicle control system (MVCS) 310 for the primary lead vehicle 302 and one or more self-propelled and self-guided secondary vehicles 304. The MVCS 310 is in signal communication with the lead vehicle 302, the trailer vehicle(s) 304, and/or the tow bar system 200. The MVCS 310 is configured to receive various inputs such as, for example, driver control inputs, inputs from various ADAS sensors, pre-programmed preferences and settings, or inputs from other sources. Based on the received inputs, the MVCS 310 constructs output(s) to optimize performance of the multi-vehicle system 300. In this way, the MVCS 310 treats the multiple vehicles as separate, but dynamically connected bodies, and translates driver inputs into optimal full-system performance.

In one example, the trailer vehicle 304 exactly follows the intended path of the lead vehicle 302, which requires the MVCS 310 to have knowledge of the surrounding external environment (e.g., curbs, lanes, other traffic, etc.). To provide this capability, the MVCS 310 is a multi-vehicle dynamic ADAS/autonomous driving system with sensing and computing capability housed in the lead vehicle 302 and/or the secondary vehicle 304 and connected via a physical tether or secure wireless connection.

As such, the MVCS 310 enables the self-propelled trailer vehicle 304 to receive commands electronically and respond actively, rather than by passive responses to mechanical inputs and constraints from the vehicle. This advantageously allows a smaller lead vehicle to tow a much larger, self-propelled and guided trailer with lessened mechanical constraint support. In this way, the lead vehicle 302 is not responsible for the chassis reactions needed to support the trailer vehicle 304 through accelerating and braking. To avoid operational conflicts with the lead vehicle, the secondary vehicle must know the intended and actual speed/heading of the lead vehicle. This information may be collected and processed by the lead vehicle to signal to the secondary vehicle how to operate, the secondary vehicle to direct itself, or a combination of both. Regardless, inputs of the lead vehicle's intended path are required to generate the performance control of the full multi-vehicle system 300.

Example operational capabilities of the MVCS 310 include:

(i) Dynamic stability control for the lead and secondary vehicle. This control is configured to handle a lead vehicle that is significantly smaller and lighter than the self-powered secondary vehicle. This will affect the sensitivity of the vehicles to driver inputs based on whole-system performance, as well as affect all outputs such as brake gains, steering assist/response, delays, and automated interventions in a manner that is proportional to the whole system.

For example, when the driver applies hard braking, the trailer vehicle 304 may need to brake first in order for the whole system 300 to stop safely without the trailer vehicle 304 overrunning the lead vehicle 302. Similarly, evasive steering maneuvers may be damped by Electronic Stability Control performance that utilizes the multi-vehicle system 300 parameters to reduce rollover or jackknife possibilities. The MVCS 310 also allows the driver to make intuitive steering inputs and have the multi-vehicle system 300 follow, even if that means adjusting the input/output relationship for the steering system of the lead vehicle 302 between an “alone mode” and a “connected mode”.

(ii) Selective regenerative braking response for multi-body energy preservation. For example, the lead vehicle driver may adjust the regenerative braking bias toward the lead vehicle or trailer vehicle in order to preserve energy for either vehicle upon arrival at a destination, or to maximize driving range of the whole system 300. This change in braking response will change the performance of the entire system, but is optimized to prevent a change in feel for the lead vehicle driver.

(iii) Reverse steering control of the entire multi-vehicle system 300. This allows the input of the driver to the steering wheel to directly translate to a turn made by the secondary vehicle, rather than requiring the lead vehicle driver to make a double-reverse turn to start a reverse backing maneuver. In one example, the driver initiates a turn with the steering wheel that directly is implemented by the secondary vehicle and the primary vehicle wheels delay turning until the secondary vehicle has established the desired path for the lead vehicle to follow. For example, when reversing and turning at the same time, the MVCS 310 may keep the wheels of the lead vehicle 302 straight when a steering input is made in order to let the entire system 300 make its turn as accurately as possible, which can be accomplished via steer-by-wire or other technology.

(iv) Sensing and outputs without physical contact, or at the tether (e.g., tow bar system 200) between the vehicles, such as force or extending sensing and local angular sensing.

(v) Multi-trailer towing. Allowing for more than one trailer vehicle 304.

With continued reference to FIG. 8 and additional reference to FIGS. 9A-9B, the multi-vehicle system 300 will be described in more detail. In the example embodiment, the lead vehicle 302 may be any suitable towing vehicle. with various levels of capability depending on the features installed. For example, the lead vehicle 302 may be a base vehicle 302a (e.g., older vehicle or without additional features), an upgraded/equipped vehicle 302b (e.g., with production trailering ADAS features), or a max capable vehicle 302c. The base lead vehicle 302a may include a powertrain 312 (ICE, BEV, hybrid, etc.), a conventional steering system 314, a trailer hitch 316 (e.g., Class II bumper hitch), and a trailer wiring harness 318 (e.g., 4-pin) with running lights 319, a brake activation system 320, and turn signal(s) 322. The trailer hitch 316 is configured to removably couple to the tow bar system 200 or directly to the trailer vehicle 304. In some examples, a non-integrated trailer information display 324 (e.g., personal device or added display) and/or a non-integrated trailer backup and surround view camera display 325 (e.g., personal device or added display) may be associated with the base lead vehicle 302a.

In the illustrated example, the lead vehicle 302 is an electric vehicle having a high voltage battery system 326 (FIG. 8) configured to power one or more electric traction motors (not shown) of the lead vehicle powertrain 312. A high voltage connection 327 is configured to electrically couple the high voltage battery system 326 with the self-powered trailer vehicle 304, for example, to provide bi-directional charging therebetween.

In one example, the upgraded lead vehicle 302b may additionally include an upgraded trailer hitch 316 (e.g., reduced weight and simplified rear hitch receiver), trailer wiring harness 318 (e.g., 7-pin), and brake activation system 320 (e.g., integrated trailer brake controller 328). In addition, the upgraded lead vehicle 302b may include a trailer blind spot monitoring system 330, a trailer camera wiring and display system 332, and an integrated tire pressure monitoring system (TPMS) 334.

In one example, the max capable lead vehicle 302c may additionally include an ADAS/autonomous driving system 340 with various features. In the example embodiment, the ADAS/autonomous driving system 340 includes a controller 342 in signal communication with a sensor suite 344, a trailer info display page or Human Machine Interface (HMI) 346 (e.g., in a cluster/center stack), and a lead vehicle Electronic Stability Control (ESC) system 348, for example, via a secure encrypted CAN bus 350. Additionally, the ADAS/autonomous driving system 340 is in signal communication with the tow bar system 200 and/or trailer vehicle 304 via a wired or wireless connection 351. As shown in FIG. 6, the tow bar system 200 includes angle sensors 218, 230 configured to sense an angle between the tow bar system 200 and the lead vehicle 302 and/or trailer vehicle 304, as well as a load cell 216 configured to sense various forces on the tow bar (e.g., trailer tongue weight, tension, compression, length change, acceleration, etc.). Additionally, the tow bar system 200 may include an extension sensor 222 (FIG. 9B) configured to measure a state or level of extension (or compression) of the tow bar.

In the illustrated example, the sensor suite 344 generally includes (in addition to sensors already described) a vehicle speed sensor 352, vehicle steering sensor 354, wheel speed sensors 356 (e.g., one for each wheel), accelerometer(s) 358, a throttle position sensor 360, a brake sensor 362, ultrasonic sensors 364, and a battery charge monitoring sensor 366. Additionally, the sensor suite 344 may include one or more cameras 368 (e.g., back up, park view side, drone, etc.), for example, for lane keep assist. However, it will be appreciated that sensor suite 344 may include any additional sensors that enable lead vehicle 302 to function as described herein. Further still, the ADAS/autonomous driving system 340 may include or be in signal communication with a brake-by-wire system 384, a steer-by-wire system 386, and a throttle-by-wire system 388.

With continued reference to FIGS. 8 and 9, in the example embodiment, the trailer vehicle 304 is a self-propelled, BEV based trailer with at least one steerable axle such as, for example, the trailer systems 10, 100 described herein. The trailer vehicle 304 may have various levels of capability depending on the features installed. For example, the trailer vehicle 304 may be a base trailer 304a with base ADAS functionality or an upgraded ADAS trailer 304b.

In the example embodiment, the base trailer vehicle 304a generally includes a hitch connection 402, a BEV powertrain 404, and a high voltage battery system 406. The hitch connection 402 is configured to removably couple to the tow bar system 200 or directly to the lead vehicle 302. The BEV powertrain 404 includes one or more electric traction motors 408 that generate and transfer torque to one or more steerable axles 410 and wheels 412 via intermediate components (e.g., a transmission, shafts, differential, etc.). The high voltage battery system 406 is configured to power the BEV powertrain 404 and electrically couple to the lead vehicle 302, for example, via the high voltage connection 327.

In the example embodiment, the base trailer vehicle 304a also includes an ADAS/autonomous driving system 420 with various features to perform assisted/autonomous trailer actuation. In one example, the ADAS/autonomous driving system 420 includes a controller 422 (e.g., ECU) in signal communication with a sensor suite 424, or example, via a secure encrypted CAN bus 426. The ADAS/autonomous driving system 420, which integrates with or is part of MVCS 310, includes a steer-by-wire module or system 430, a brake-by-wire module or system 432, and a throttle-by-wire module or system 434.

The ADAS/autonomous driving system 420 is also in signal communication with a TPMS 436, one or more colored status lights 438 that may be placed in various locations of trailer vehicle 304, a backup camera 440, and one or more vehicle surround cameras 442. Additionally, the ADAS/autonomous driving system 420 is further in signal communication with the tow bar system 200 and/or lead vehicle 302 (e.g., ADAS/autonomous driving system 340) via the wired or wireless connection 351. In this way, MVCS 310 is configured to receive signals from the lead vehicle 302 and/or tow bar system 200 indicating system conditions such as, for example, lead vehicle steering, throttle position, wheel speed, relative angular positioning, etc. In some examples, the ADAS/autonomous driving system 420 is integrated with a decoupled remote driving application 444 usable, for example, on a remote electronic device (e.g., smart phone).

In the illustrated example, the sensor suite 424 generally includes (in addition to those previously mentioned) a trailer speed sensor 450, a trailer steering sensor 452, wheel speed sensors 454 (e.g., one for each wheel), accelerometer(s) 456, a brake sensor 458, and a battery charge monitoring sensor 460. In the upgraded trailer vehicle 304b, the sensor suite 424 further includes one or more front ultrasonic obstacle detection sensors 462, one or more rear ultrasonic obstacle detection sensors 464, one or more cross-path/blind spot monitoring sensors 466 (e.g., corner radar), a lane positioning camera suite 468, one or more ultrasonic lateral obstacle detection sensors 470, and an automatic emergency braking system 472. However, it will be appreciated that sensor suite 424 may include any suitable sensor that enables trailer vehicle 304 or MVCS 310 to function as described herein.

As previously described, the MVCS 310 is integrated with the lead vehicle 302 and trailer vehicle(s) 304 to provide control of the entire multi-vehicle system 300 through a single control input (driver). In this way, the MVCS 310 is configured to automatically perform various trailering maneuvers and lead/trailer vehicle controls based on one or more signals from the lead vehicle 302, trailer vehicle 304, and/or tow bar system 200. Such signals, for example, are received from the lead vehicle ADAS/autonomous driving system 340, the trailer ADAS/autonomous driving system 420, and/or tow bar system 200. Accordingly, the MVCS 310 may utilize or include one or more controllers 311, including vehicle controllers 342, 422, to receive the one or more signals and execute one or more algorithms to provide the desired multi-vehicle control response to improve all aspects of the multi-vehicle system dynamic performance including steering, braking, acceleration, reversing maneuvers, and additional ADAS/autonomous function.

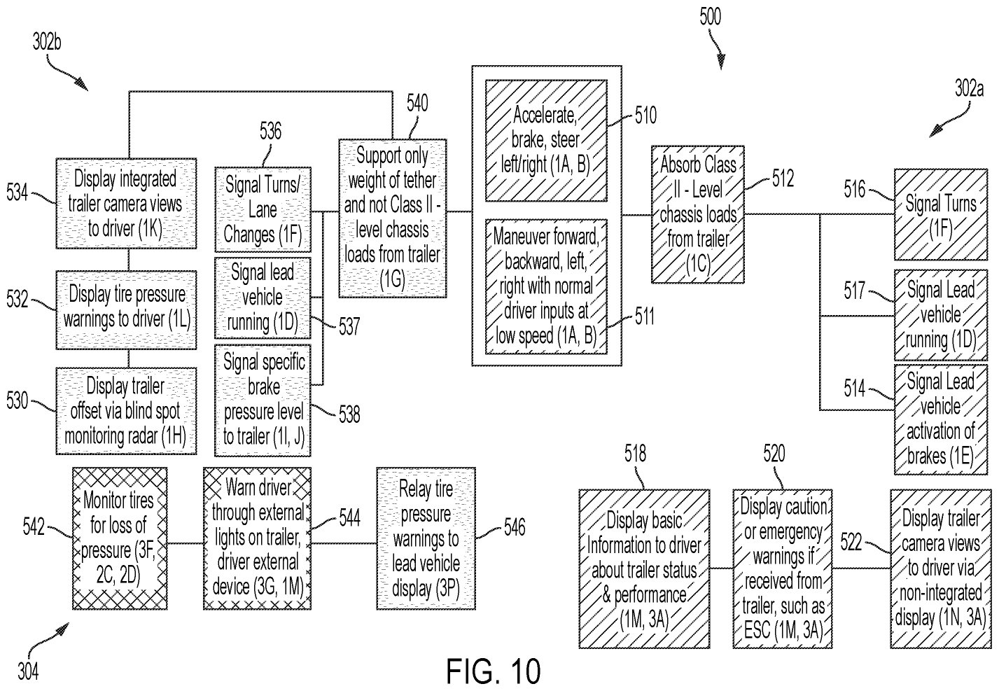

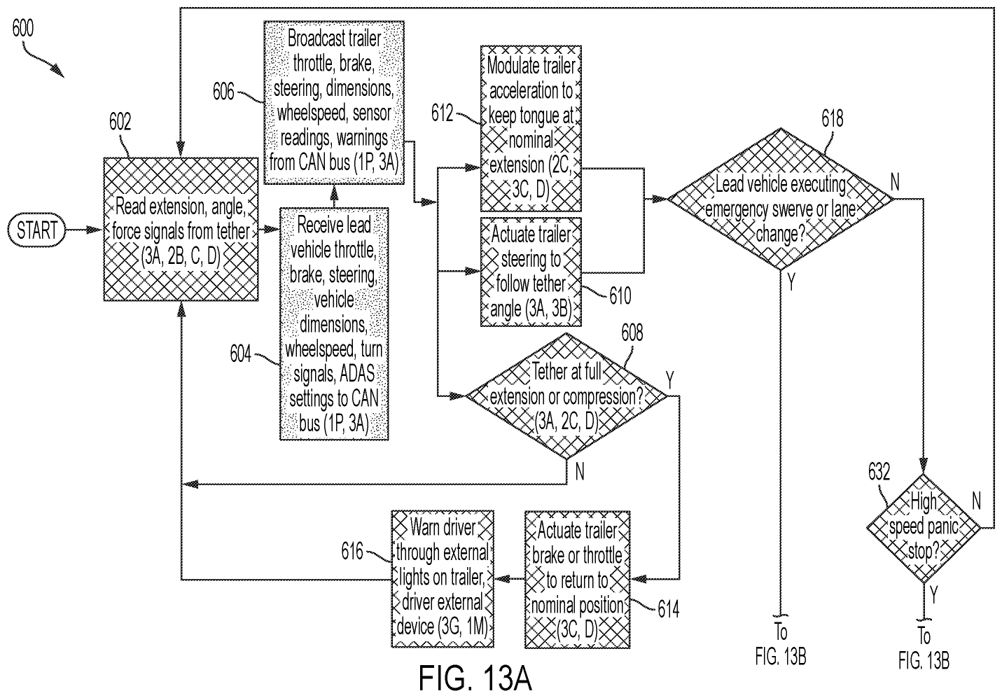

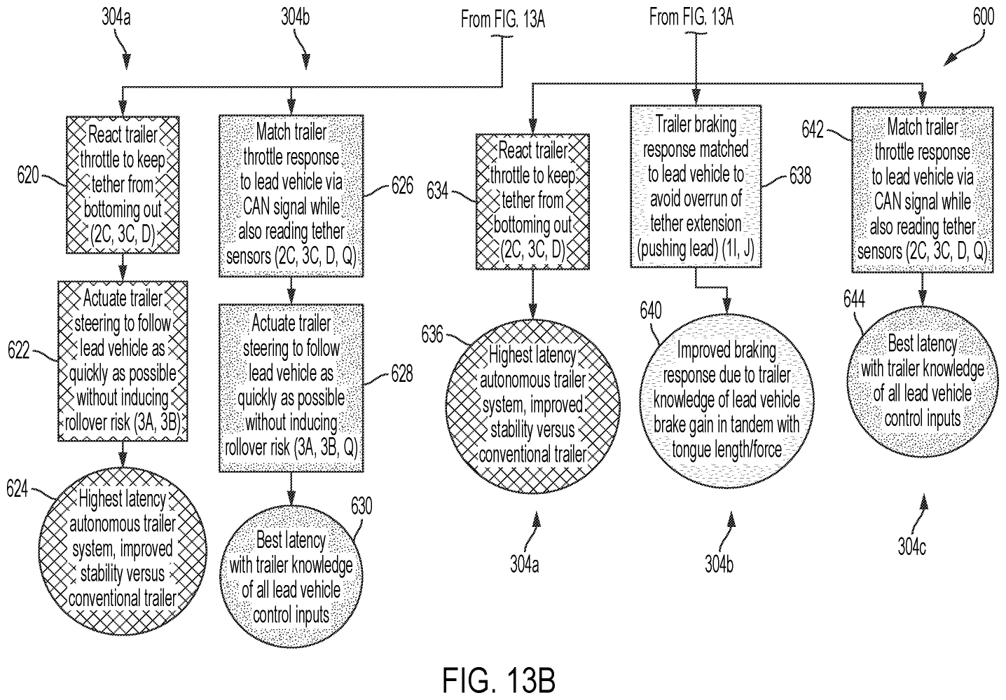

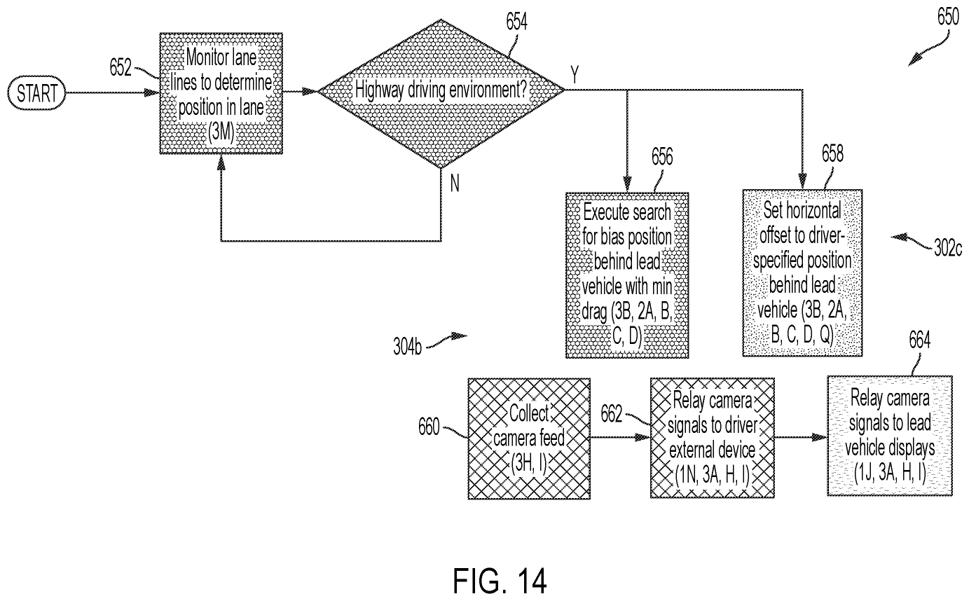

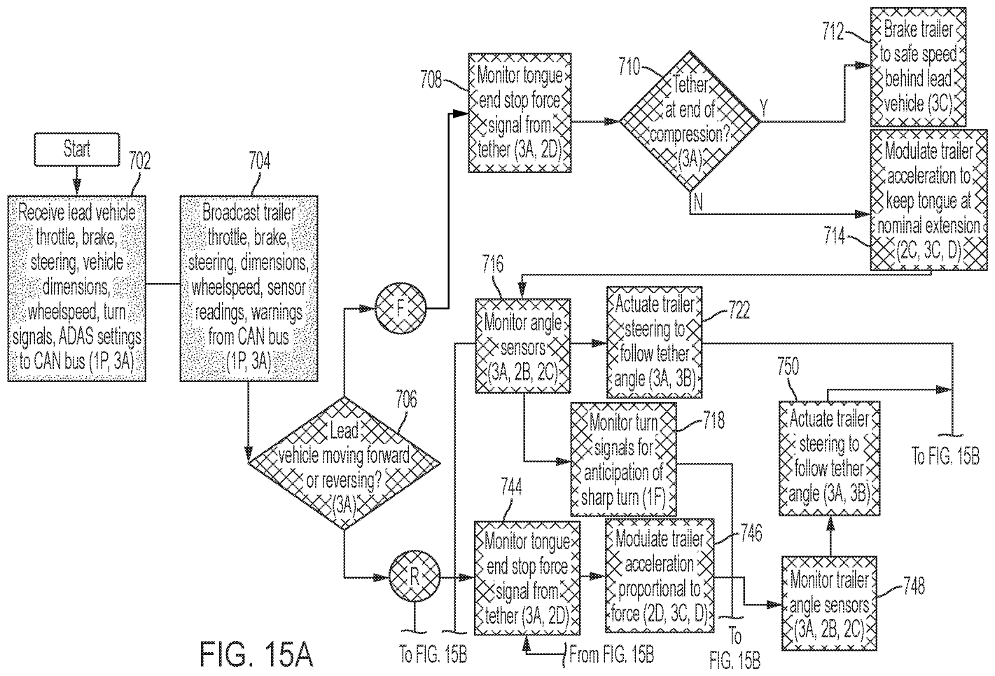

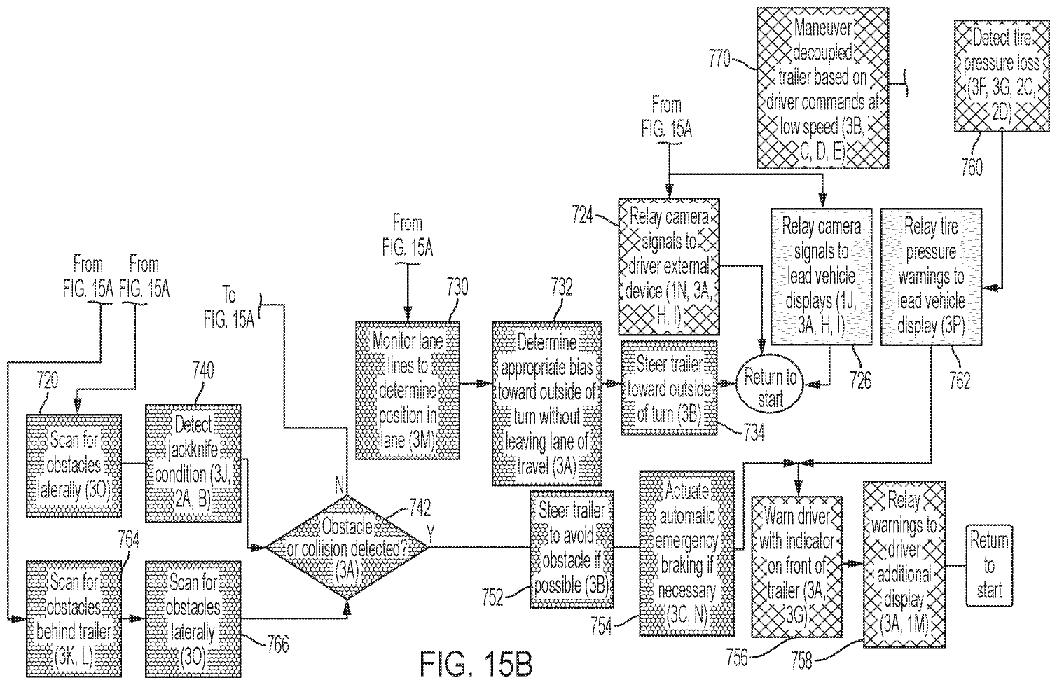

With reference now to FIGS. 10-15, architectures and operations of the MVCS 310 and multi-vehicle system 300 will be described in more detail. FIGS. 10-12 illustrate example architectures for operational capability and control of the multi-vehicle system 300 for both high speed maneuvering/stability and low speed forward/reverse maneuvering. FIGS. 13-14 illustrate methods of dynamic control during the high-speed maneuvering and stability operations. In one example, high speed maneuvers are greater than or equal to 45 kph. FIGS. 15A-15B illustrate methods of dynamic control during the low speed forward and reverse maneuvering dynamics operations. In one example, low speed forward maneuvers are less than 45 kph, and low speed reverse maneuvers are less than 11 kph. As previously discussed, lead vehicle 302 may have various levels of capability including base lead vehicle 302a, upgraded lead vehicle 302b, and max capable lead vehicle 302c. Trailer vehicle 304 may have various levels of capability including base trailer vehicle 304a and upgraded trailer vehicle 304b. In the example embodiments, the architectures and/or shading illustrate lead and trailer vehicle capability.

FIG. 10 illustrates an example architecture 500 for MVCS 310 of operational capability and control of the lead vehicle 302 during high-speed and/or low-speed dynamic maneuvering. In the example embodiment, for base vehicle capability and control, lead vehicle 302a includes the following features. For high-speed maneuvering, at block 510, lead vehicle 302 is configured to accelerate, brake, and steer left/right utilizing powertrain 312 and steering system 314. For low-speed maneuvering, at block 511, lead vehicle 302 is configured to maneuver forward, backward, left, and right with normal driver inputs at low-speed utilizing powertrain 312 and steering system 314. In most cases operations at blocks 510, 511 are based on driver input, but MVCS 310 is also configured to provide such control or assist to the lead vehicle 302 when necessary. For example, MVCS 310 is configured to make acceleration, braking, and steering corrections on the lead vehicle 302 depending on conditions of the multi-vehicle system 300.

At block 512, lead vehicle 302 is configured to absorb chassis loads from the trailer vehicle 304 via the trailer hitch 316. At block 514, lead vehicle 302 is configured to signal lead vehicle activation of brakes via trailer wiring harness 318 and brake activation system 320. At block 516, lead vehicle 302 is configured to signal lane changes via the trailer wiring harness 318 and trailer turn signals 322. Additionally, at block 517, during low-speed maneuvers, lead vehicle 302 is configured to signal that the lead vehicle is running.

Additionally, MVCS 310 is configured to display information on the non-integrated displays 324, 325 of the base lead vehicle 302a configuration. For example, at block 518, MVCS 310 is configured to display basic information to the driver about trailer status and performance on the non-integrated trailer information display 324 based on signals from the trailer controller 422. At block 520, MVCS 310 is configured to display caution or emergency warnings to the driver on the non-integrated trailer information display 324, if received from the trailer controller 422 (e.g., ESC). At block 522, MVCS 310 is configured to display trailer camera views to the driver via the non-integrated display 325.

In the example embodiment, for upgraded vehicle capability and control, lead vehicle 302b includes the following additional features. At block 530, the MVCS 310 is configured to display a trailer offset based on signals from the trailer blind spot monitoring system 330. In one example, trailer offset is an offset of the trailer vehicle 304 relative to a centerline and path of the lead vehicle 302. This information may be displayed, for example, on an integrated in-vehicle display 323 (e.g., infotainment unit) or non-integrated trailer information display 324. This function may only be used during high-speed maneuvers. At block 532, the MVCS 310 is configured to display one or more tire pressure warnings to the driver based on signals from the TPMS system 334. This information may be displayed, for example, on the integrated in-vehicle display 323 or non-integrated trailer information display 324. At block 534, MVCS 310 is configured to display integrated trailer camera views to the driver based on signals from the trailer camera wiring and display system 332. This information may be displayed, for example, on the integrated in-vehicle display 323 or non-integrated trailer backup and surround view camera display 325.

At block 536, MVCS 310 is configured to signal lane changes (e.g., high speed) or turns (e.g., low speed) on the trailer vehicle turn signals 322 based on turning signals from the lead vehicle 302. At block 537, lead vehicle 302 is configured to signal that the lead vehicle is running. This function may only be used during high-speed maneuvers. At block 538, MVCS 310 is configured to signal specific brake pressure levels to the trailer brake activation system 320 based on braking signals from the lead vehicle 302. At block 540, lead vehicle 302 supports only the weight of the tether (e.g., tow bar system 200) and not any weight of the trailer vehicle 304, due to the self-propelled capability of the trailer vehicle 304.

FIG. 10 also illustrates tire pressure monitoring capability with a base trailer capability and upgraded lead vehicle capability. At block 542, MVCS 310 is configured to monitor trailer tires for pressure loss based on signals from TPMS 436. At block 544, MVCS 310 is configured to warn the driver of low trailer tire pressure via trailer status lights 438 and/or the non-integrated trailer information display 324. If equipped, at block 546, MVCS 310 relays low tire pressure signals to the lead vehicle 302 via the TPMS 334.

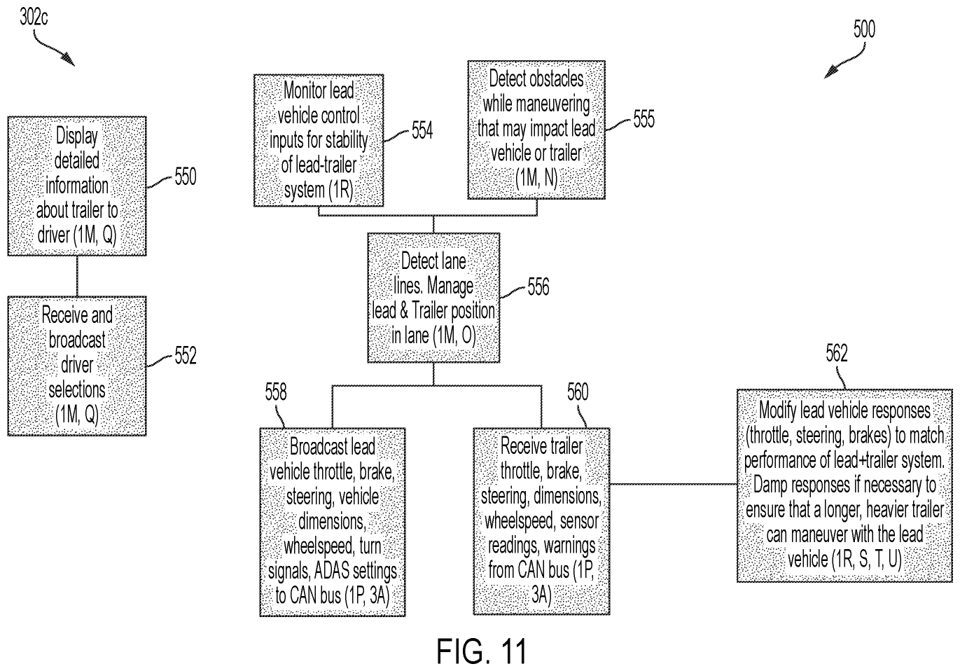

With reference now to FIG. 11, with max capability vehicle capability and control, lead vehicle 302c includes the following additional features. At block 550, MVCS 310 is configured to display detailed information about trailer vehicle 304 to the driver. This information may be displayed, for example, on the integrated in-vehicle display 323 or non-integrated trailer information display 324. At block 552, MVCS 310 is configured to receive and broadcast driver selected options made on the display 323, 324. Example driver selected options include battery charge preservation bias for wither vehicle for max range, the level of intervention the trailer will make to assist the driver, the type of feedback provided to the driver, or allowing the driver to select various “widgets” to view information about the trailer. These widgets can include tether angle sensors, tether extension, trailer throttle-brake-steering, and any type of performance changes to the lead vehicle that the MVCS 310 makes to match the performance of the two vehicles 302, 304.

At block 554, MVCS 310 is configured to monitor lead vehicle control inputs for stability of the multi-vehicle system 300 based on signals from the lead vehicle ESC system 348. This feature may be available only during high-speed maneuvers. At block 555, MVCS 310 is configured to detect obstacles while maneuvering that may impact the lead vehicle 302 or trailer vehicle 304, based on signals from the ADAS/autonomous driving system 340 including ultrasonic sensors 364. This feature may be available only during low-speed maneuvers.

At block 556, MVCS 310 is configured to detect lane lines based on signal(s) from the camera(s) 368, and subsequently manage positions of the lead vehicle 302 and trailer vehicle 304 within the lane based on driver selection input into the display 323, 324. At block 558, MVCS 310 is configured to broadcast lead vehicle throttle, brake, steering, vehicle dimensions, wheel speed, turn signals, and ADAS settings across the CAN bus 350 to the trailer vehicle controller 422. At block 560, MVCS 310 is configured to receive trailer vehicle throttle, brake, steering, vehicle dimensions, wheel speed, sensor readings, and warnings from the trailer vehicle 304 via trailer vehicle controller 422 and CAN bus 350. At block 562, MVCS 310 is configured to modify lead vehicle responses (e.g., throttle, steering, brakes) to match performance of the multi-vehicle system 300. For example, MVCS 310 is configured to match the performance of a smaller lead vehicle to the physical capability of a larger trailer, where the large trailer will have a predetermined known operation limit for acceleration, braking, and steering capability that the lead vehicle will need to match in order to avoid large loads on the tether. This may be done by limiting or reducing the lead vehicle's performance in these categories. As such, MVCS 310 may then damp vehicle responses, if necessary, for example to ensure that a longer and/or heavier trailer can maneuver with the lead vehicle 302. Such control may be accomplished via the ESC system 348, the lead vehicle brake-by-wire system 384, steer-by-wire system 386, and throttle-by-wire system 388.

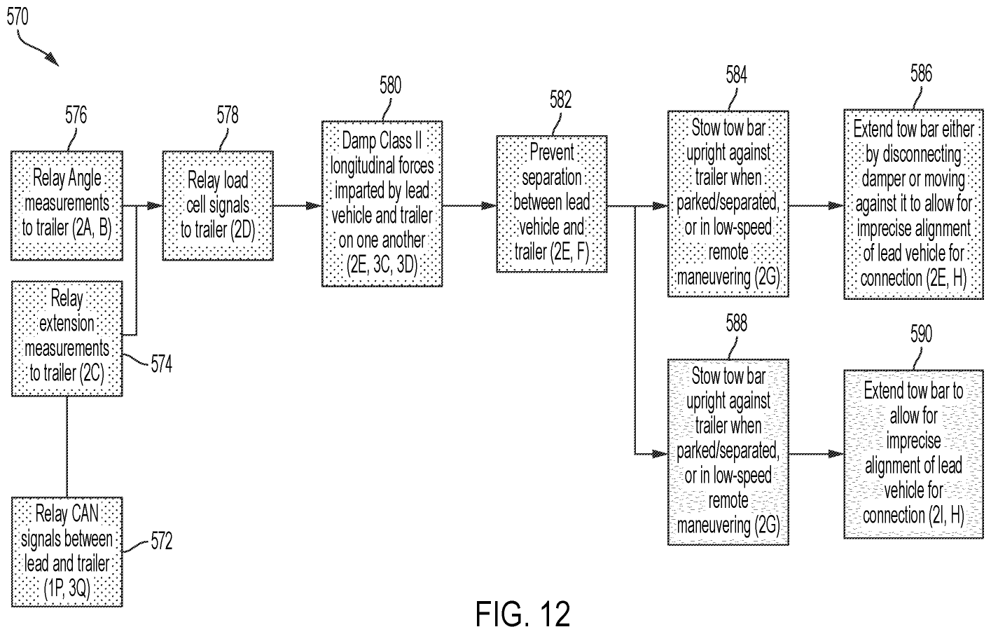

FIG. 12 illustrates an example architecture 570 for MVCS 310 of operational capability and control of the multi-vehicle system 300 utilizing the tow bar system 200 during high-speed and/or low speed maneuvering. At block 572, MVCS 310 is configured to receive signals from the tow bar system 200 and relay signals on the secure CAN buses 350, 426. At block 574, MVCS 310 is configured to receive and relay extension measurements from the tow bar system 200 (e.g., via extension sensor 222). In one example, extension measurements are taken at the front biasing mechanism 254 and/or rear biasing mechanism 258. At block 576, MVCS 310 is configured to receive and relay angular measurements from tow bar system angle sensors 218, 230.

In the example embodiment, at block 578, MVCS 310 is configured to receive and relay load cell signals from tow bar system load cell 216. At block 580, MVCS 310 is configured to damp longitudinal forces imparted by the lead vehicle 302 and trailer vehicle 304 onto one another. In the base lead vehicle configuration 302a, the tether 200 may be configured to dampen higher forces (e.g., Class II longitudinal forces). In the upgraded lead vehicle 302b configuration, the tether 200 may only dampen small longitudinal forces. And in the max capable lead vehicle configuration, no damping may be required due to system capability, as described herein in more detail. In some examples, the forces are damped by safety chains 224 (FIG. 9B), the damper system 214, and/or via trailer vehicle control via the trailer brake-by-wire system 432 and throttle-by-wire system 434. At block 582, the tow bar system 200 is configured to prevent separation between the lead vehicle 302 and trailer vehicle 304 via safety chains 224 and the weight bearing structure 226 (FIG. 9B) of the tow bar system 200.

In the base lead vehicle configuration 302a, the tether 200 includes the capability of blocks 584 and 586. At block 584, the tow bar system 200 includes a pivoting structure 228 (FIG. 9B) configured to enable the tow bar to be stowed upright against the trailer vehicle 304 when parked/separated from lead vehicle 302 or during low-speed remote maneuvering. At block 586, the tow bar system 200 includes an extension mechanism 229 (FIG. 9B) configured to extend the tow bar either by disconnecting damper system 214 or moving against it to allow for connection to the lead vehicle 302 during imprecise alignment therebetween.

In the upgraded and/or max capable lead vehicle 302b, 302c configuration, the tether includes the capability of blocks 588 and 590. At block 588, the tow bar system 200 includes pivoting structure 228 (FIG. 9B) configured to enable the tow bar to be stowed upright against the trailer vehicle 304 when parked/separated from lead vehicle 302 or during low-speed remote maneuvering. At block 590, the tow bar system 200 includes extension mechanism 229 (FIG. 9B) with mild force damping (21) configured to extend the tow bar either by disconnecting damper system 214 or moving against it to allow for connection to the lead vehicle 302 during imprecise alignment therebetween.

With reference now to FIGS. 13A-13B, an example method 600 of dynamic control and stability of multi-vehicle system 300 and MVCS 310 during high-speed maneuvering is illustrated. At step 602, MVCS 310 monitors extension, angle, and force signals from the trailer controller 422 and the tow bar system 200 (e.g., load cell 216 and angle sensors 218, 230). At step 604, MVCS 310 monitors lead vehicle throttle, brake, steering, vehicle dimensions, wheel speed, turns signals, and ADAS settings. At step 606, MVCS 310 monitors trailer vehicle throttle, brake, steering, vehicle dimensions, wheel speed, sensor readings, and warnings.

In the example embodiment, MVCS 310 may then perform steps 608, 610, and 612 simultaneously or in any order. At step 608, MVCS 310 determines if the tether (e.g., tow bar system 200) is at full extension or compression based on signals from the trailer controller 422, extension sensor 222, and/or load cell 216. If no, control returns to step 602. If yes, at step 614, MVCS 310 actuates the trailer vehicle brake and/or throttle to return the trailer tongue to a predefined nominal position utilizing the trailer vehicle brake-by-wire system 432 and throttle-by-wire system 434. At step 616, MVCS 310 may optionally warn the driver of the full extension/compression condition via trailer status lights 438 and/or external display 324. Control then returns to step 602.

At step 610, MVCS 310 actuates the trailer steer-by-wire system 430 to follow the lead vehicle path as determined by the tow bar angle sensors 218, 230 and lead vehicle 302 steering angle. At step 612, MVCS 310 modulates trailer vehicle acceleration to maintain the trailer tongue at a nominal, predefined extension from the lead vehicle 302. In one example, this is accomplished based on extension signals from the tow bar system 200 and modulating via the trailer vehicle brake-by-wire system 432 and throttle-by-wire system 434. Control then proceeds to step 618, and MVCS 310 monitors the lead vehicle 302 to determine if the lead vehicle 302 is executing a predefined emergency swerve and/or lane change. If yes, control proceeds to step 620 or 626 depending on trailer vehicle capability. If no, control proceeds to step 632.

MVCS 310 performs step 620 or 626 depending on lead/trailer vehicle capability. With base trailer vehicle 304a capability, control proceeds to step 620. With max capable lead vehicle capability, control proceeds to step 626. At step 620, MVCS 310 monitors tether extension sensor 222 and controls the trailer vehicle brake-by-wire system 432 and throttle-by-wire system 434 to prevent the tether 200 from bottoming out. At step 622, MVCS 310 controls the trailer vehicle steer-by-wire system 430 such that the trailer vehicle 304 follows the lead vehicle 302. This steering adjustment may be performed at a pace to reduce rollover risk. Control ends at step 624 with MVCS 310 having provided improved stability for the high latency autonomous trailer vehicle 304 compared to a conventional trailer. Control may also return to step 602.

At step 626, with the max capable lead vehicle, MVCS 310 monitors tether extension sensor 222 and matches the trailer throttle response (via trailer brake/throttle systems 432, 434) to the lead vehicle 302. MVCS 310 displays information related to this step on trailer display/HMI 346. At step 628, MVCS 310 controls the trailer vehicle steer-by-wire system 430 such that the trailer vehicle 304 follows the lead vehicle 302. This steering adjustment may be performed at a pace to reduce rollover risk. MVCS 310 displays information related to this step on trailer display/HMI 346. Control ends at step 630 with MVCS 310 having provided high latency performance with trailer knowledge of all lead vehicle control inputs. Control may also return to step 602.

If the lead vehicle 302 is not executing a predefined emergency swerve and/or lane change at step 618, control proceeds to step 632 and MVCS 310 determines if the lead vehicle 302 is performing a high-speed emergency or panic stop. If no, control returns to step 602. If yes, MVCS 310 proceeds to steps 634, 638, and/or 642 depending on lead/trailer vehicle capability.

With base trailer vehicle capability, control proceeds to step 634 and MVCS 310 monitors tether extension sensor 222 and controls the trailer vehicle brake-by-wire system 432 and throttle-by-wire system 434 to prevent the tether 200 from bottoming out. Control ends at step 636 with MVCS 310 having provided improved stability for the high latency autonomous trailer vehicle 304 compared to a conventional trailer. Control may also return to step 602.

With the upgraded lead vehicle capability, control proceeds to step 638 and MVCS 310 controls the trailer vehicle brake-by-wire system 432 via the lead vehicle integrated trailer brake controller 328 to match the trailer braking response to the lead vehicle braking response to facilitate preventing overrun of the tether 200 and pushing of the lead vehicle 302. Control ends at step 640 with MVCS 310 having provided improved braking response due to trailer knowledge of lead vehicle brake gain in tandem with tongue length/force information. Control may also return to step 602.

With the max capable lead vehicle, control proceeds to step 642 and MVCS 310 monitors tether extension sensor 222 and matches the trailer throttle response (via trailer brake/throttle systems 432, 434) to the lead vehicle 302. MVCS 310 displays information related to this step on trailer display/HMI 346. Control ends at step 644 with MVCS 310 having provided high latency performance with trailer knowledge of all lead vehicle control inputs. Control may also return to step 602.

With reference now to FIG. 14, another example method 650 of operating multi-vehicle system 300 and MVCS 310 during high-speed maneuvering and stability dynamics is illustrated. At step 652, MVCS 310 monitors road lane lines to determine a position of the multi-vehicle system 300 based on signals from the lane positioning camera suite 468. At step 654, MVCS 310 determines if the multi-vehicle system 300 is in a highway driving environment based on the information from step 652. If no, control returns to step 652. If yes, control proceeds to step 656 or 658 depending on system capability.

With the upgraded ADAS trailer vehicle 304b, at step 656, MVCS 310 determines and executes a horizontal offset bias position for the trailer vehicle 304 behind the lead vehicle 302 that produces minimum aerodynamic drag on the lead vehicle 302, trailer vehicle 304, or the entire multi-vehicle system 300. In one example, MVCS 310 determines the horizontal offset bias position based on signals from angle sensors 218, 230, extension sensor 222, and load cell 216, and subsequently executes the offset bias position via steer-by-wire system 430.

With the max capable lead vehicle 302c, at step 658, MVCS 310 sets the trailer vehicle 304 to a horizontal offset bias position based on a driver specified position behind the lead vehicle 302. In one example, MVCS 310 sets the horizontal offset bias position with the steer-by-wire system 430 based on signals from angle sensors 218, 230, extension sensor 222, load cell 216, and driver input from trailer info display/HMI 346.

In an additional optional operation, at step 660, MVCS 310 monitors camera signals from cameras 440, 442. At step 662, MVCS 310 relays the camera signals to non-integrated display 325. With upgraded lead vehicle 302b, MVCS 310 may additionally relay signals from cameras 440, 442 and front ultrasonic sensors 462 of the lead vehicle blind spot monitoring system 330 to integrated in-vehicle display 323.

With reference now to FIGS. 15A-15B, an example method 700 of dynamic control of multi-vehicle system 300 and MVCS 310 during low-speed forward and reverse maneuvering is illustrated. At step 702, MVCS 310 monitors lead vehicle throttle, brake, steering, vehicle dimensions, wheel speed, turns signals, and ADAS settings. At step 704, MVCS 310 monitors trailer vehicle throttle, brake, steering, vehicle dimensions, wheel speed, sensor readings, and warnings. At step 706, MVCS 310 determines if the lead vehicle 302 is performing a forward maneuver or a reverse maneuver. Control proceeds to step 708 if lead vehicle 302 is performing a forward maneuver. Control proceeds to steps 744/764 if lead vehicle 302 is performing a reverse maneuver.

Low-Speed Forward Maneuver. At step 708, MVCS 310 monitors a tongue end stop force signal from the tow bar system 200 via load cell 216. At step 710, MVCS 310 determines if the tow bar system 200 is at the end of compression (e.g., maximum compression). If yes, at step 712, MVCS 310 controls the trailer brake-by-wire system 432 to brake the trailer vehicle 310 to a predetermined “safe” speed behind the lead vehicle 302. Control may then end or return to step 702. If no, at step 714, MVCS 310 modulates trailer vehicle acceleration to maintain the trailer tongue at a nominal, predefined extension from the lead vehicle 302. In one example, this is accomplished based on signals from extension sensor 222 and modulating via the trailer vehicle brake-by-wire system 432 and throttle-by-wire system 434.

In the example embodiment, MVCS 310 may then perform steps 716, 718, and 720 simultaneously or in any order.

At step 716, MVCS 310 monitors tow bar system angle sensors 218, 230. At step 722, MVCS 310 actuates the trailer steer-by-wire system 430 to follow the lead vehicle path as determined by the tow bar angle sensors 218, 230 and lead vehicle 302 steering angle. MVCS 310 then relays camera signals to one or more lead vehicle displays. In the illustrated example, MVCS 310 relays signals from cameras 440, 442 and front ultrasonic sensors 462 of the lead vehicle blind spot monitoring system 330 to the non-integrated display 325 (step 724) and the integrated in-vehicle display 323 (step 726). Control then ends or returns to start.

Returning to step 718, MVCS 310 monitors lead vehicle turn signals 322 to detect a predefined sharp turn. Control then proceeds to step 730 and MVCS 310 monitors road lane lines to determine a position of the multi-vehicle system 300 based on signals from the lane positioning camera suite 468. At step 732, MVCS 310 determines a bias for the trailer vehicle 304 toward an outside of the turn without leaving the lane of travel. In one example, this enables a longer trailer vehicle to avoid undercutting the turn and colliding with obstacles as it follows a shorter lead vehicle around the turn. At step 734, MVCS 310 actuates trailer steer-by-wire system 430 to steer the trailer vehicle 304 toward an outside of the turn as determined in step 732. Control then ends or returns to start.

Returning to step 720, MVCS 310 monitors ultrasonic lateral obstacle detection sensors 470 to detect nearby obstacles. Control then proceeds to step 740 and MVCS 310 monitors front ultrasonic obstacle detection sensors 462 and tow bar angle sensors 218, 230 to detect a potential jackknife condition. At step 742, MVCS 310 determines if there is an obstacle or potential collision detected based on steps 720 and 740. If no, control proceeds to step 744. If yes, control proceeds to step 752.

At step 744, if no obstacle or collision is detected, MVCS 310 monitors tow bar load cell 216 to determine tongue end stop force. At step 746, MVCS 310 controls the trailer brake-by-wire system 432 and throttle-by-wire system 434 to modulate trailer acceleration proportional to the force monitoring in step 744. At step 748, MVCS 310 monitors tow bar angle sensors 218, 230. At step 750, MVCS 310 actuates the trailer steer-by-wire system 430 to follow the lead vehicle path as determined by the tow bar angle sensors 218, 230 and lead vehicle 302 steering angle. Control then proceeds to steps 724 and/or 726, previously described.

Returning to step 742, if an obstacle or potential collision is detected, control proceeds to step 752 and MVCS 310 is configured to control trailer steer-by-wire system 430 to avoid the detected obstacle (if possible). At step 754, MVCS 310 is configured to actuate trailer brake-by-wire system 432 and/or automatic emergency braking system 472 to perform an emergency braking, if necessary to avoid a collision. Control then proceeds to step 756 and MVCS 310 illuminates one or more of the colored status lights 438 on the front of the trailer vehicle 304 to warn the driver of the detected obstacle or potential collision. At step 758, MVCS 310 relays obstacle/collision warnings to one or more displays 323-325. Control then ends or returns to start.

Additionally, at step 760, MVCS 310 monitors TPMS 436, extension sensor 222, and/or tow bar angle sensors 218, 230 to detect a tire pressure loss in trailer vehicle 304. If a tire pressure loss is detected, at step 762, MVCS 310 relays tire pressure warnings via integrated TPMS 334 to lead vehicle integrated display 323. Control then proceeds to step 756 and MVCS 310 illuminates one or more of the colored status lights 438 on the front of the trailer vehicle 304 to warn the driver of the detected tire pressure loss. At step 758, MVCS 310 optionally relays pressure warnings to one or more displays 323-324. Control then ends or returns to start.

Low-Speed Reverse Maneuver. Returning to step 706, MVCS 310 determines if the lead vehicle 302 is performing a forward maneuver or a reverse maneuver. If the lead vehicle 302 is performing a reverse maneuver, MVCS 310 may then perform steps 744, 764 simultaneously or in any order. Step 744 and subsequent steps are previously described. At step 764, MVCS 310 monitors rear ultrasonic obstacle detection sensors 464 to detect nearby obstacles. At step 766, MVCS 310 monitors ultrasonic lateral obstacle detection sensors 470 to detect nearby obstacles. Control then proceeds to step 742 and subsequent steps, as previously described. With reference to step 770, in some examples, the multi-vehicle system 300 may be controlled as described herein utilizing the integrated remote driving application when trailer vehicle 304 is separated from the lead vehicle 302.

Described herein are systems and methods for dynamically controlling a system of two or more self-powered, self-guided vehicles. The control system includes input and output parameters for the multiple motorized and steerable vehicles controlled by a single driver. As such, rather than having a driver actuate one vehicle and a traditional trailer passively react, all vehicles of the multi-vehicle system are actuated (e.g., controlled) by a single control input. This control affects all aspects of the vehicle dynamic performance including steering, braking, acceleration, reversing maneuvers, and ADAS or autonomous driving systems.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A multi-vehicle control system (MVCS) for dynamic stability and control of a multi-vehicle system having a lead vehicle and a trailer vehicle each with independent propulsion and control, the MVCS comprising:
a controller in signal communication with the lead vehicle and a trailer vehicle advanced driver assistance system (ADAS) or autonomous driving system via a controller area network (CAN) bus, the controller configured to:
receive throttle, brake, and steering signals respectively from a throttle-by-wire system, a brake-by-wire system, and a steer-by-wire system of the trailer vehicle ADAS or autonomous driving system;
receive lead vehicle control inputs from the lead vehicle; and
modify a throttle, a steering, and a braking of the trailer vehicle, based on the received lead vehicle control inputs, to dynamically stabilize the multi-vehicle system such that the trailer vehicle does not induce forces that accelerate or slow the lead vehicle.

2. The MVCS of claim 1, wherein the controller is further configured to modify a throttle, a steering, and a braking of the lead vehicle, based on the received trailer vehicle throttle, brake, and steering signals, to further dynamically stabilize the multi-vehicle system such that the trailer vehicle does induce forces that accelerate or slow the lead vehicle.

3. The MVCS of claim 1, wherein the controller is further configured to display information about the trailer vehicle to a display integrated into the lead vehicle and/or a non-integrated trailer information display.

4. The MVCS of claim 1, wherein the controller is in signal communication with a lead vehicle ADAS or autonomous driving system.

5. The MVCS of claim 4, wherein the controller is further configured to:
detect lane lines based on signals received from one or more cameras of the lead vehicle ADAS or autonomous driving system; and
modify the steering of the trailer vehicle, based on the detected lane lines, to locate the trailer vehicle in a predetermined position within the detected lane lines.

6. The MVCS of claim 5, wherein the controller is further configured to:
modify the steering of the lead vehicle, based on the detected lane lines, to locate the lead vehicle in a second predetermined position within the detected lane lines relative to the trailer vehicle.

7. The MVCS of claim 1, wherein the lead vehicle and the trailer vehicle are coupled by a tow bar system that includes:
at least one angle sensor configured to sense a first angle between the lead vehicle and the tow bar system, and a second angle between the trailer system and the tow bar system;
an extension sensor configured to measure a level of extension of the tow bar system; and
a load cell configured to sense forces on the tow bar system,
wherein the controller is in signal communication with the at least one angle sensor, the extension sensor, and the load cell.

8. The MVCS of claim 7, wherein the controller is further configured to:
receive signals from the at least one angle sensor, the extension sensor, and the load cell; and
further modify the throttle, the steering, and the braking of the trailer vehicle, based on the signals received from the tow bar system, to dynamically stabilize the multi-vehicle system such that the trailer vehicle does not induce forces that accelerate or slow the lead vehicle.

9. The MVCS of claim 8, wherein the controller is further configured to modify a throttle, a steering, and a braking of the lead vehicle, based on the signals received from the tow bar system, to further dynamically stabilize the multi-vehicle system such that the trailer vehicle does not induce forces that accelerate or slow the lead vehicle.

10. The MVCS of claim 1, wherein the controller is further configured to:
match a throttle response of the trailer vehicle to a throttle input of the lead vehicle; and
match a braking response of the trailer vehicle to a braking input of the lead vehicle.

11. A control method for dynamic stability of a multi-vehicle system having a multi-vehicle control system (MVCS) in signal communication with a lead vehicle and a trailer vehicle each with independent propulsion and control, the method comprising:
receive, by a controller of the MVCS having one or more processors, throttle, brake, and steering signals respectively from a throttle-by-wire system, a brake-by-wire system, and a steer-by-wire system of an advanced driver assistance system (ADAS) or autonomous driving system of the trailer vehicle;
receive, by the controller, lead vehicle control inputs from the lead vehicle; and
modify, by the controller, a throttle, a steering, and a braking of the trailer vehicle, based on the received lead vehicle control inputs, to dynamically stabilize the multi-vehicle system such that the trailer vehicle does not induce forces that accelerate or slow the lead vehicle.

12. The method of claim 11, further comprising:
modifying, by the controller, a throttle, a steering, and a braking of the lead vehicle, based on the received trailer vehicle throttle, brake, and steering signals, to further dynamically stabilize the multi-vehicle system such that the trailer vehicle does not induce forces that accelerate or slow the lead vehicle.

13. The method of claim 11, further comprising:
displaying, by the controller, information about the trailer vehicle to a display integrated into the lead vehicle and/or a non-integrated trailer information display.

14. The method of claim 11, wherein the controller is in signal communication with a lead vehicle ADAS or autonomous driving system, the method further comprising:
detecting lane lines, by the controller, based on signals received from one or more cameras of the lead vehicle ADAS or autonomous driving system; and
modifying the steering of the trailer vehicle, by the controller, based on the detected lane lines, to locate the trailer vehicle in a predetermined position within the detected lane lines.

15. The method of claim 14, further comprising:
modifying the steering of the lead vehicle, by the controller, based on the detected lane lines, to locate the lead vehicle in a second predetermined position within the detected lane lines relative to the trailer vehicle.

16. The method of claim 11, wherein the multi-vehicle system includes a tow bar system coupling the lead vehicle and the trailer vehicle, the tow bar system including (i) at least one angle sensor configured to sense a first angle between the lead vehicle and the tow bar system, and a second angle between the trailer system and the tow bar system, (ii) an extension sensor configured to measure a level of extension of the tow bar system, and (iii) a load cell configured to sense forces on the tow bar system, the method further comprising:
receiving, by the controller, signals from the at least one angle sensor, the extension sensor, and the load cell; and
further modifying, by the controller, the throttle, the steering, and the braking of the trailer vehicle, based on the signals received from the tow bar system, to dynamically stabilize the multi-vehicle system such that the trailer vehicle does not induce forces that accelerate or slow the lead vehicle.

17. The method of claim 16, further comprising:
modifying, by the controller, a throttle, a steering, and a braking of the lead vehicle, based on the signals received from the tow bar system, to further dynamically stabilize the multi-vehicle system such that the trailer vehicle does not induce forces that accelerate or slow the lead vehicle.

18. The method of claim 11, further comprising:
matching, by the controller, a throttle response of the trailer vehicle to a throttle input of the lead vehicle; and
matching, by the controller, a braking response of the trailer vehicle to a braking input of the lead vehicle.

19. A control method for dynamic stability of a multi-vehicle system having a lead vehicle and a trailer vehicle each with independent propulsion and control, and a multi-vehicle control system (MVCS) in signal communication with an advanced driver assistance system (ADAS) or autonomous driving system of the trailer vehicle, the method comprising:
performing, by a controller of the MVCS having one or more processors, the following during high-speed maneuvering:
controlling the trailer vehicle to follow the lead vehicle through emergency lane changes in a path that reduces rollover risk; and
determining and executing a horizontal offset between the lead vehicle and the trailer vehicle to reduce aerodynamic drag on the multi-vehicle system; and
performing, by the controller, the following during low-speed maneuvering:
controlling the trailer vehicle to follow the lead vehicle through a forward turn on a path to avoid obstacles detected by the trailer vehicle ADAS or autonomous driving system.

20. The method of claim 19, wherein the MVCS is further in signal communication with an ADAS or autonomous driving system of the lead vehicle, the method further comprising:
performing, by the controller, the following during high-speed maneuvering:
modifying driver input responses of the lead vehicle, including modifying throttle, brake, and steering outputs, based on signals from the trailer vehicle ADAS or autonomous driving system; and
performing, by the controller, the following during low-speed maneuvering:
controlling the trailer vehicle to follow the lead vehicle through the forward turn further based on lead vehicle driver inputs;
initiating a rearward turn of the trailer vehicle based on driver inputs from the lead vehicle, and subsequently controlling the lead vehicle to follow a path of the trailer vehicle through the rearward turn;
scanning for hazards utilizing the ADAS or autonomous driving systems of both the lead vehicle and the trailer;
alerting a driver of the lead vehicle of detected hazards; and
executing one or more maneuvers in the lead vehicle and/or the trailer vehicle to prevent a collision with the detected hazards.
